(19) United States
(12) Patent Application Publication
(10) Pub. No.: US 2025/0229183 A1
(43) Pub. Date: Jul. 17, 2025

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Yuka Iwasaki, Tokyo (JP); Masashi Kachi, Tokyo (JP); Akari Oku, Tokyo (JP)

(73) Assignee: CYGAMES, INC., Tokyo (JP)

(21) Appl. No.: 19/170,746

(22) Filed: Apr. 4, 2025

Related U.S. Application Data
(63) Continuation of application No. PCT/JP2023/027242, filed on Jul. 25, 2023.

(30) Foreign Application Priority Data
Nov. 1, 2022 (JP) 2022-175332

(51) Int. Cl. A63F 13/63; A63F 13/533

(52) U.S. Cl. CPC A63F 13/63; A63F 13/533

(57) ABSTRACT

A non-transitory computer readable medium stores a program causing a computer to execute: displaying a selection screen including a first display area where a display type of an appearance of an object displayed on a game screen is selectable, and where a common display type with a common appearance for a plurality of objects or a special display type with different appearances for the plurality of objects is selectable, and a second display area where an application range of the display type selected by a player is selectable, and where a predetermined object or a plurality of objects are selectable as the application range; displaying, when the common display type is selected, at least the predetermined object with an appearance corresponding to the common display type; and displaying, when the special display type is selected, an object satisfying a display condition with an appearance corresponding to the special display type.

### CROSS REFERENCE TO RELATED APPLICATIONS

This application is a continuation application of International Application No. PCT/JP2023/027242, filed on Jul. 25, 2023, which claims priority to Japanese Patent Application No. 2022-175332, filed on Nov. 1, 2022, the entire contents of which are incorporated by reference herein.

### BACKGROUND ART

### Technical Field

The present invention relates to an information processing program, an information processing method, and an information processing system.

As described in Patent Document 1 for example, a game that can put an outfit selected by a player on a character displayed on a game screen is known in the related art. In this manner, the outfit of the character can be set in accordance with the preference of the player, which increases the player's attachment to the character, and enhances the enjoyment of the game.

In addition, Patent Document 1 discloses collectively putting the same outfit on a plurality of characters. By providing the collective setting function that can be used on a plurality of characters in this manner, the operability for the player is enhanced.

### CITATION LIST

### Patent Literature

Patent Document 1: JP 7089546 B

### SUMMARY OF INVENTION

### Technical Problem

Although the above-described collective setting function is employed in various game fields, in the related art, the collective setting function can only set the same outfit, items, and the like for all target characters. Thus, for example, when putting different outfits on a plurality of characters, the player needs to set the outfits individually for each of the characters, which requires complicated operations for the player.

An object of the present invention is to provide an information processing program, an information processing method, and an information processing system capable of enhancing the operability for a player.

### Solution to Problem

To solve the problem described above, an information processing program is provided that causes a computer to execute:
processing of displaying a selection screen including a first display area where a display type of an appearance of an object displayed on a game screen is selectable, and where a common display type with a common appearance for a plurality of the objects or a special display type with different appearances for a plurality of the objects is selectable, and a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.

The object may include an object displayable with an appearance corresponding to the special display type and an object non-displayable with an appearance corresponding to the special display type,
identification information for identifying an object displayable with an appearance corresponding to the special display type and an object non-displayable with an appearance corresponding to the special display type may be provided, and
in a case where an object non-displayable with an appearance corresponding to the special display type has satisfied a predetermined condition, a computer is caused to execute processing of enabling the object to be displayed with an appearance corresponding to the special display type.

The game screen may include a game screen displaying the object arranged in each of a position 1 and a position 2, the information processing program may cause a computer to execute processing of enabling a player to select the object arranged in the position 1 or the position 2, the predetermined object may be an object selected by a player, and
the processing of displaying the selection screen may
enable, in a case where an object arranged in the position 1 is selected, selection of whether to include all objects arranged in the position 1 as the application range in the second display area or whether to include all objects displayed on the game screen, and
enable, in a case where an object arranged in the position 2 is selected, selection of whether to include all objects arranged in the position 2 as the application range in the second display area or whether to include all objects displayed on the game screen as the application range in the second display area.

To solve the problem described above, an information processing method executed by one or more computers is provided that includes:
processing of displaying a selection screen including a first display area where a display type of an appearance of an object displayed on a game screen is selectable, and where a common display type with a common appearance for a plurality of the objects or a special display type with different appearances for a plurality of the objects is selectable, and a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.

To solve the problem described above, an information processing system including one or more computers is provided, the information processing system executing:
by the one or more computers, processing of displaying a selection screen including a first display area where a display type of an appearance of an object displayed on a game screen is selectable, and where a common display type with a common appearance for a plurality of the objects or a special display type with different appearances for a plurality of the objects is selectable, and a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.

### Effects of Disclosure

According to the present invention, it is possible to enhance the operability for the player.

### BRIEF DESCRIPTION OF DRAWINGS

FIG. 1 is an explanatory diagram illustrating a schematic configuration of an information processing system.

FIG. 2A is a diagram for describing a hardware configuration of a player terminal.

FIG. 2B is a diagram for describing a hardware configuration of a server.

FIG. 3 is a diagram for describing an example of a home screen.

FIG. 4 is a diagram for describing an example of a live show music piece selection screen.

FIG. 5A is a first diagram for describing an example of a live show preparation screen.

FIG. 5B is a second diagram for describing an example of the live show preparation screen.

FIG. 6 is a diagram for describing an example of a character selection dialog.

FIG. 7A is a first diagram for describing an example of an outfit selection dialog.

FIG. 7B is a second diagram for describing an example of an outfit selection dialog.

FIG. 7C is a third diagram for describing an example of an outfit selection dialog.

FIG. 7D is a fourth diagram for describing an example of an outfit selection dialog.

FIG. 8A is a first diagram for describing an example of an outfit selection dialog according to a modified example.

FIG. 8B is a second diagram for describing an example of an outfit selection dialog according to a modified example.

FIG. 9 is a diagram for describing information relating to a character.

FIG. 10 is a diagram for describing information associated with game content IDs.

FIG. 11 is a diagram for describing outfit IDs.

FIG. 12 is a diagram for describing information associated with outfit IDs.

FIG. 13 is a diagram for describing head IDs.

FIG. 14 is a diagram for describing tail IDs.

FIG. 15 is a diagram for describing a case of setting a common outfit using a collective setting function.

FIG. 16 is a diagram for describing a case of setting an individual outfit using the collective setting function.

FIG. 17 is a diagram for describing a configuration of a memory in a player terminal and a function as a computer.

FIG. 18 is a flowchart for describing an example of live show performance preparation processing in a player terminal.

FIG. 19 is a flowchart for describing an example of in-live-show-preparation-screen-display processing in a player terminal.

FIG. 20 is a flowchart for describing an example of outfit selection processing in a player terminal.

FIG. 21 is a flowchart for describing an example of outfit setting processing in a player terminal.

FIG. 22 is a flowchart for describing an example of character information setting processing in a player terminal.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In this specification and the drawings, elements having substantially the same function and configuration are denoted by the same reference numerals, and redundant description thereof will be omitted, and elements not directly relating to the present invention will not be illustrated.

### Overall Configuration of Information Processing System S

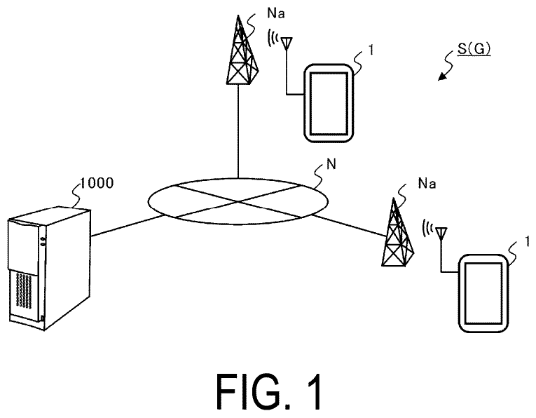

FIG. 1 is an explanatory diagram illustrating a schematic configuration of an information processing system S. The information processing system S is a so-called client-server system including a player terminal 1, a server 1000, and a communication network N including a communication base station Na.

The player terminal 1 can establish communication with the server 1000 via the communication network N. The player terminal 1 includes a wide range of electronic devices capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various kinds of information (player information) for each player who plays the game. In addition, the server 1000 performs updating of the accumulated information on the basis of an operation input from the player terminal 1.

The communication base station Na is connected to the communication network N and wirelessly exchanges information with the player terminal 1. The communication network N includes a cellular network, an Internet network, a local area network (LAN), a dedicated line, or the like, and establishes a wireless or wired communication connection between the player terminal 1 and the server 1000.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

Hardware Configuration of Player Terminal 1 and Server 1000

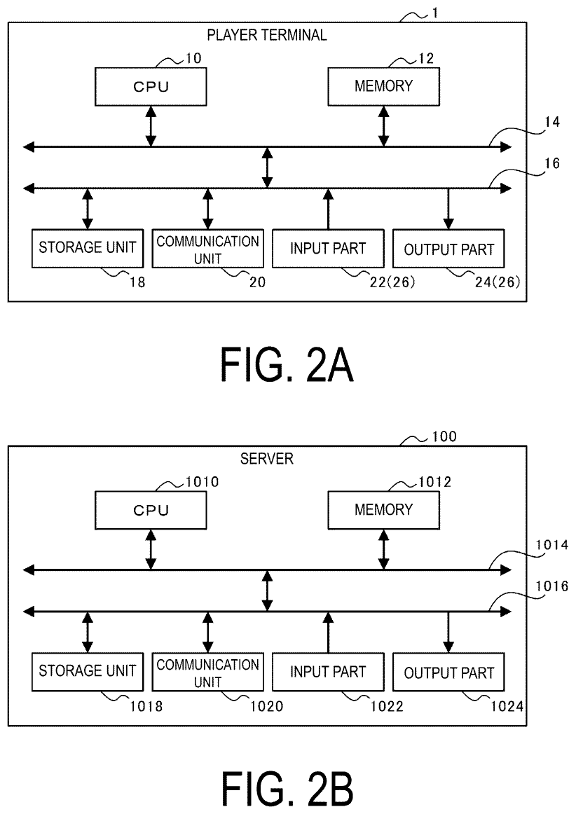

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 includes a wide range of apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a touch panel 26 that functions as the input part 22 and the output part 24.

### Details of Game

Next, details of a game provided by the information processing system S (game apparatus G) of the present embodiment will be described using an example. Before starting the game, the player downloads in advance a dedicated application from the server 1000 to the player terminal 1 and registers a player ID in the server 1000. When the application is activated, the player terminal 1 receives various kinds of information stored in the server 1000 and displays a game screen on the touch panel 26.

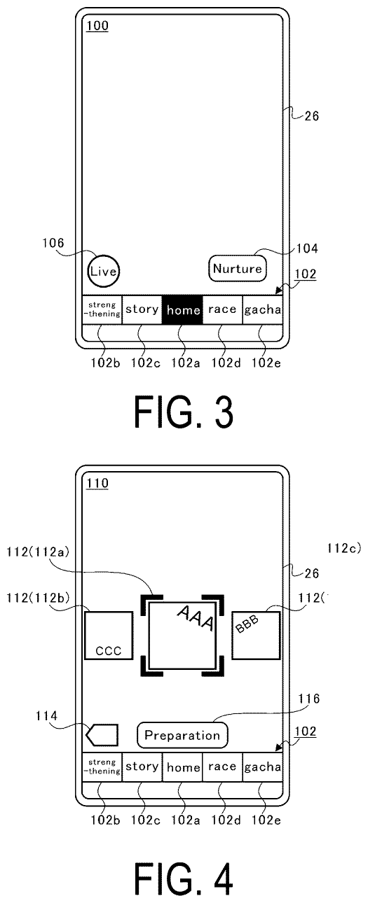

FIG. 3 is a diagram for describing an example of a home screen 100. When the game application is activated on the player terminal 1, the home screen 100 is displayed on the touch panel 26. A menu bar 102 is displayed at a lower portion of the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the touch panel 26 can be identified. When the home screen selection operation portion 102a is tapped, the home screen 100 illustrated in FIG. 3 is displayed on the touch panel 26.

When the strengthening screen selection operation portion 102b is tapped, a strengthening screen (not illustrated) is displayed. On the strengthening screen, it is possible to strengthen a nurture game content possessed by the player. In the present embodiment, a plurality of types of nurture game contents are provided from an administrator. A player can obtain a nurture game content by being successful in a lottery called a gacha. In addition, a predetermined nurture game content may be granted free of charge to the player from the administrator. The player can possess the nurture game content obtained via a lottery and the nurture game content granted from the administrator.

The nurture game content is used in the nurture game described below, and a nurture game content ID is set for each nurture game content. In addition, one game content ID is always associated with a nurture game content, that is, a nurture game content ID. As will be described in detail below, a game content ID is provided for each game content. Here, the game content is a character, and one character is associated with a game content ID. Thus, one character can be considered to be always associated with a nurture game content. Hereinafter, the game content may be referred to as a character. In addition, a nurture game content possessed by the player may be referred to as a possessed nurture game content, and a character associated with the possessed nurture game content may be referred to as a possessed character.

A level is associated with the nurture game content. Here, any one of levels 2 to 5 is associated with the nurture game content. In addition to the game content (game content ID) described above, the level, and a parameter, a nurture game content name is associated with the nurture game content. The respective nurture game contents are grouped into a plurality of types.

A plurality of nurture game contents belonging to the same group type are all associated with the same game content ID and the same nurture game content name. On the other hand, different levels and parameters are associated with the plurality of nurture game contents belonging to the same group type. Here, as the level becomes higher, a parameter that is more advantageous in the nurture game is associated with a plurality of nurture game contents belonging to the same group type.

The player can increase the level associated with their possessed nurture game content by strengthening the possessed nurture game content. More strictly, by strengthening the possessed nurture game content, the player can possess a higher level nurture game content belonging to the same group type than the currently possessed nurture game content.

For example, here it is assumed that the player has strengthened a level 2 possessed nurture game content. In this case, a level 3 nurture game content that belongs to the same group type as the level 2 possessed nurture game content and is raised in level becomes the possessed nurture game content. Accordingly, the player can use the level 3 possessed nurture game content thereafter in the nurture game. Here, the same group type refers to a collection of the same characters at different levels managed by different IDs. It is obvious that the configuration is not limited to this configuration, and the same character (nurture game content of the same character) may be managed with the same ID, and only the associated data may be changed.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in the nurture game described below can be caused to participate. On the racing game selection screen, the player can select a racing game in which the nurtured character is caused to participate. An example of a racing game is a team competition game in which a team formed by a plurality of nurtured characters and a team of other players selected by a computer are made to compete with each other. The team competition game has a game property of competing with other players for ranking.

When the gacha screen selection operation portion 102e is tapped, a gacha screen (not illustrated) is displayed. On the gacha screen, the player can play the gacha lottery by spending in-game currency. The player can obtain a nurture game content from the gacha lottery.

In addition, on the home screen 100, a nurture game operation portion 104 is provided above the menu bar 102. When the nurture game operation portion 104 is tapped, a nurture game screen is displayed. In the nurture game, the player can select any one possessed character as the nurture target character by selecting a possessed nurture game content. Then, in the nurture game, various parameters associated with the nurture target character are updated, and a nurtured character is finally generated. The player can play the above-described racing game or the like using the nurtured character generated in the nurture game.

Note that the details of the game described above is merely an example. The technical matters described below are applicable not only to the nurture game but also to any game genre such as a sports game, an action game, a shooting game, a simulation game, a roll playing game (RPG), and a puzzle game.

In the present embodiment, the player can view a live show performance. In the present embodiment, a live show performance is a performance in which a vocal sound and background music (BGM) are output in accordance with a live show video in which a character is singing and/or dancing. Hereinafter, a live show performance will be described in detail. A live show select button 106 is provided on the home screen 100. When the live show select button 106 is tapped, a live show music piece selection screen 110 is displayed.

FIG. 4 is a diagram for describing an example of the live show music piece selection screen 110. The live show performance is provided with a plurality of patterns in which a music piece and a live show video are different. In other words, a live show performance is provided for each music piece, and a different live show video is played for each music piece. On the live show music piece selection screen 110, the player can select the music piece to be viewed, that is, the type of live show performance.

Specifically, a jacket image 112 provided for each music piece is displayed on the live show music piece selection screen 110. Here, a jacket image 112a is displayed substantially at the center of the live show music piece selection screen 110. Jacket images 112b and 112c are displayed on the left and right sides of the jacket image 112a. The jacket image 112a is displayed larger than the jacket images 112b and 112c. On the live show music piece selection screen 110, the jacket image 112a displayed large at the center of the screen indicates the music piece currently being provisionally selected.

When a swipe/flick operation in the left-and-right direction is input in the vicinity of the area where the jacket image 112 is displayed on the live show music piece selection screen 110, the jacket image 112 displayed on the live show music piece selection screen 110 is sequentially switched. The player can select a music piece for the live show performance by switching the jacket image 112a displayed substantially at the center of the live show music piece selection screen 110.

Note that a music piece for a live show performance includes a music piece with which the player can view a live show performance free of charge and a music piece with which only players who satisfy an unlock condition can view a live show performance. Examples of the unlock condition include that a predetermined story image has been viewed as described above, that a predetermined condition has been achieved in the above-described racing game, nurture game, or the like, and that a predetermined character is possessed. However, the unlock condition is not particularly limited. In addition, the unlock condition is not essential, and all players may be able to view a live show performance unconditionally. Further, some live show performances may be viewable by paying a predetermined price using in-game currency or real currency.

On the live show music piece selection screen 110, a return button 114 and a live show preparation button 116 are displayed. When the return button 114 is tapped, the screen is switched from the live show music piece selection screen 110 to the home screen 100. When the live show preparation button 116 is tapped, the music piece provisionally selected is set as the selected music piece, and a live show preparation screen 120 is displayed.

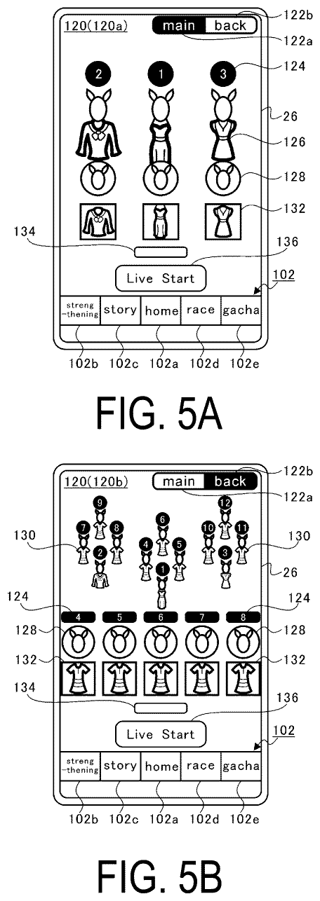

FIG. 5A is a first diagram for describing an example of the live show preparation screen 120. FIG. 5B is a second diagram for describing an example of the live show preparation screen 120. As described above, in the live show performance, a live show video is played on the touch panel 26. A plurality of characters appear in the live show video played at this time. The player can select and set a character to appear in the live show video. Note that the number of characters appearing in the live show video is set in advance for each music piece, and the player needs to set the number of characters set for each music piece.

In addition, an arrangement, that is, positions, of characters appearing in the live show video is set for each music piece. The positions are roughly classified into a main position and a back position. The player can select a character to be arranged at each of the main position and the back position. The character arranged at the main position is displayed for a longer time and stands out more in the live show video than the character arranged at the back position. Further, although detailed description is omitted, the character arranged at the main position is in charge of vocals and is a character who sings a music piece in the live show video.

The number of main positions and back positions and the positional relationship between characters displayed in the live show video are set for each music piece. Three main positions and nine back positions are set for the music piece illustrated in FIGS. 5A and 5B. Each position is associated with a number. Here, position numbers 1 to 3 are main positions, and position numbers 4 to 12 are back positions. Here, the positions are roughly classified into two positions of the main position and the back position, but the types of positions are not limited to this. The number of positions may be any number.

A main position selection operation portion 122a and a back position selection operation portion 122b are provided in an upper portion of the live show preparation screen 120. When the main position selection operation portion 122a is tapped, a character to be arranged at the main position can be selected on the live show preparation screen 120 as illustrated in FIG. 5A. Further, when the back position selection operation portion 122b is tapped, a character to be arranged at the back position can be selected on the live show preparation screen 120 as illustrated in FIG. 5B. Hereinafter, on the live show preparation screen 120, a screen on which a character to be arranged at the main position can be selected is referred to as a main setting screen 120a, and a screen on which a character to be arranged at the back position can be selected is referred to as a back setting screen 120b.

Note that the music piece may be provided with only the main position and not provided with the back position. When the music piece provided with only the main position is selected, the back position selection operation portion 122b is displayed grayed-out on the live show preparation screen 120. In this case, when the back position selection operation portion 122b is tapped, an indication that no back position is provided is displayed. That is, when a music piece provided with only the main position is selected, the back position selection operation portion 122b is not displayed.

On the main setting screen 120a, as illustrated in FIG. 5A, a position number identification display 124 indicating the number of the main position is displayed. On the main setting screen 120a, the numbers of all the main positions set for the selected music piece are displayed by the position number identification display 124. In the example illustrated in FIG. 5A, three position number identification displays 124 labelled with 1 to 3 are displayed. At a lower portion of the position number identification display 124, an image image 126 of a character currently set at each main position is displayed.

More strictly, the player can set a character for each position number. Thus, on the main setting screen 120a, the image image 126 of the character set to the number indicated in the position number identification display 124 is displayed at the lower portion of the position number identification display 124.

The entire body of the character is displayed in the image image 126, and the face of the character currently set to each main position number can be identified. Hereinafter, a part of the whole body of the character above the neck including the face is referred to as the head. The image image 126 includes a head image of the character currently set. A character icon 128 is displayed below the image image 126. The head of the character currently set is displayed in the character icon 128.

When the character icon 128 is tapped, the main position number is put in a selected state. For example, in a case where the character icon 128 below the position number identification display 124 labelled with the number 3 is tapped, number 3 is put in a selected state. Further, for example, in a case where the character icon 128 below the position number identification display 124 labelled with the number 1 is tapped, number 1 is put in a selected state. When the character icon 128 is tapped, a character selection dialog 150 is displayed.

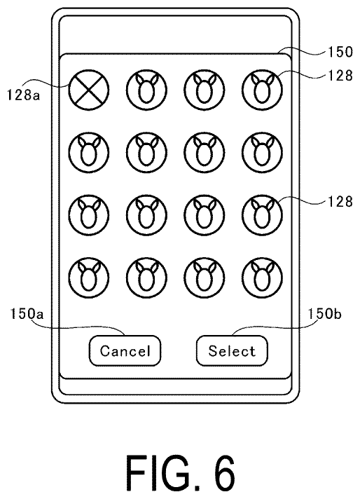

FIG. 6 is a diagram for describing an example of the character selection dialog 150. In the character selection dialog 150, a plurality of character icons 128 corresponding to the characters possessed by the player are displayed. In the character selection dialog 150, the character icons 128 corresponding to all possessed characters are displayed. Thus, the number of character icons 128 displayed in the character selection dialog 150 matches the number of characters possessed by the player.

One not-designated button 128a is displayed at the upper left of the character selection dialog 150. The not-designated button 128a is an operation portion for selecting not to designate a character. When the not-designated button 128a is tapped, one mob character is randomly selected from a plurality of mob characters prepared in advance. Note that the mob character is a character prepared separately from the characters that can be possessed by the player.

In addition, a cancel button 150a and a select button 150b are provided at a lower portion of the character selection dialog 150. When the cancel button 150a is tapped, the character selection dialog 150 is closed, and the live show preparation screen 120 immediately before the character selection dialog 150 is displayed is displayed. When any one of the character icons 128 is tapped in the character selection dialog 150, the character associated with the tapped character icon 128 is put in a provisionally selected state. When the not-designated button 128a is tapped, a randomly determined mob character is put in a provisionally selected state.

When the select button 150b is tapped with any one of the characters in the provisionally selected state, the character in the provisionally selected state is set to a position number provisionally selected. When the character selected by the player is set to the position number, the character selection dialog 150 is closed, and the live show preparation screen 120 immediately before the character selection dialog 150 is displayed is displayed. At this time, in a case where the set character is changed, an image corresponding to the changed character is displayed on the live show preparation screen 120.

For example, as illustrated in FIG. 5A, it is assumed that the character icon 128 below the position number identification display 124 labelled with the number 1 is tapped on the main setting screen 120a. When the character is changed in the character selection dialog 150, the main setting screen 120a is displayed when the character selection dialog 150 is closed. At this time, the image image 126 and the character icon 128 corresponding to the changed character are displayed on the main setting screen 120a.

Further, as illustrated in FIG. 5B, the positional relationship between the main position and the back position in the live show video is displayed in the upper portion of the back setting screen 120b. Here, an image image 130 of the character currently set for each number is displayed in correspondence with the number.

On the back setting screen 120b, the position number identification display 124 labelled with the back position number is displayed. In the example illustrated in FIG. 5B, five position number identification displays 124 labelled with 4 to 8 are displayed. The character icon 128 is displayed below the position number identification display 124 in the same manner as described above. When the character icon 128 displayed on the back setting screen 120b is tapped, the character selection dialog 150 is displayed in the same manner as when the character icon 128 is tapped on the main setting screen 120a. The player can select and change the character to be set to each back position number by tapping the character icon 128 on the back setting screen 120b.

Note that, in the example illustrated in FIG. 5B, the back positions 4 to 12 are provided. When a swipe/flick operation in the left direction is input on the back setting screen 120b, the position number identification display 124 and the character icon 128 corresponding to the back position number 9 onward are displayed.

As described above, the player can set a character to be arranged at each number of the main position by tapping the character icon 128 on the main setting screen 120a. In a similar manner, the player can set the character to be arranged at each back position number by tapping the character icon 128 on the back setting screen 120b.

When the live show preparation screen 120 is displayed for the first time after a music piece has been selected, predetermined characters are set to all positions as an initial setting. Thus, the player can change the character to be arranged at each position from the initially set character to another character on the live show preparation screen 120. However, when the live show preparation screen 120 is displayed for the first time, no characters need to be set for some or all of the positions. Alternatively, for a music piece for which a live show performance has been previously viewed, the character set last may be set as the initial setting.

Further, on the live show preparation screen 120, an outfit icon 132 is displayed below the character icon 128. As will be described in detail below, the player can select and set the outfit to be worn by the character by tapping the outfit icon 132. As for the outfits, predetermined outfits are set for all characters as the initial setting. Note that, on the live show preparation screen 120, all positions are never set to a state with an unset character and outfit. In other words, on the live show preparation screen 120, all positions are set to a state with a set character and outfit.

The live show preparation screen 120 is also provided with an auto-set button 134. When the auto-set button 134 is tapped, an auto-set screen (not illustrated) is displayed. On this auto-set screen, the player can select either the main position or the back position and then select “recommended” or “random” for each of the character and the outfit. When “recommended” is selected, a “recommended” character or outfit preset for each music piece is set for the main position or the back position selected by the player. When “random” is selected, the character or the outfit determined by a random lottery is set at the main position or the back position selected by the player.

When a start button 136 provided on the live show preparation screen 120 is tapped, the live show performance is started. At the start of the live show performance, a live show video is generated in which the character set on the live show preparation screen 120 performs singing and/or dancing at the set position. At this time, the character appearing in the live show video is wearing the outfit set on the live show preparation screen 120.

As described above, on the live show preparation screen 120, the player can set the outfit to be worn for each character. At this time, by diversifying the kinds of outfits, the live show videos are diversified, and the enjoyment of the game is enhanced. On the other hand, in the present embodiment, the number of characters appearing in the live show performance may be very large depending on the music piece. In this manner, when the number of characters appearing is large, in a case where outfits are individually set for all the characters, the operation of the player becomes complicated. In the present embodiment, outfits are set as follows in order to realize diversification in performance while simplifying the operations of the player.

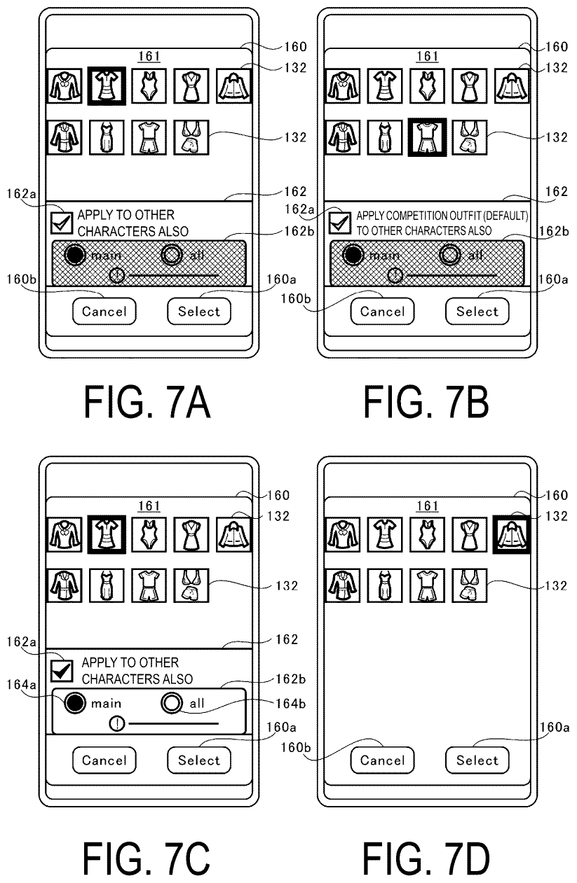

FIG. 7A is a first diagram for describing an example of an outfit selection dialog 160. FIG. 7B is a second diagram for describing an example of the outfit selection dialog 160. FIG. 7C is a third diagram for describing an example of the outfit selection dialog 160. FIG. 7D is a fourth diagram for describing an example of the outfit selection dialog 160. When the outfit icon 132 is tapped on the live show preparation screen 120 illustrated in FIG. 5A or 5B, a character to which an outfit is to be set, that is, a target character is set.

Here, the character set to the number of the position associated with the tapped outfit icon 132 is the target character. Specifically, the position number identification display 124 is displayed above the outfit icon 132 tapped on the live show preparation screen 120. The character set to the number indicated in the position number identification display 124 is set as the target character.

When the outfit icon 132 is tapped, the outfit selection dialog 160 illustrated in FIG. 7A is displayed. A first display area 161 is provided at the top of the outfit selection dialog 160. The outfit icon 132 corresponding to an outfit wearable by the target character is displayed in the first display area 161. In the first display area 161, the outfit icon 132 corresponding to the outfit currently set to the target character is highlighted.

When the outfit icon 132 is tapped in the first display area 161, the outfit associated with the tapped outfit icon 132 is provisionally selected. A select button 160a and a cancel button 160b are provided at a lower portion of the outfit selection dialog 160. When the select button 160a is tapped, the outfit in the provisionally selected state is set as the outfit of the target character. When the cancel button 160b is tapped, the outfit selection dialog 160 is closed and the live show preparation screen 120 is displayed.

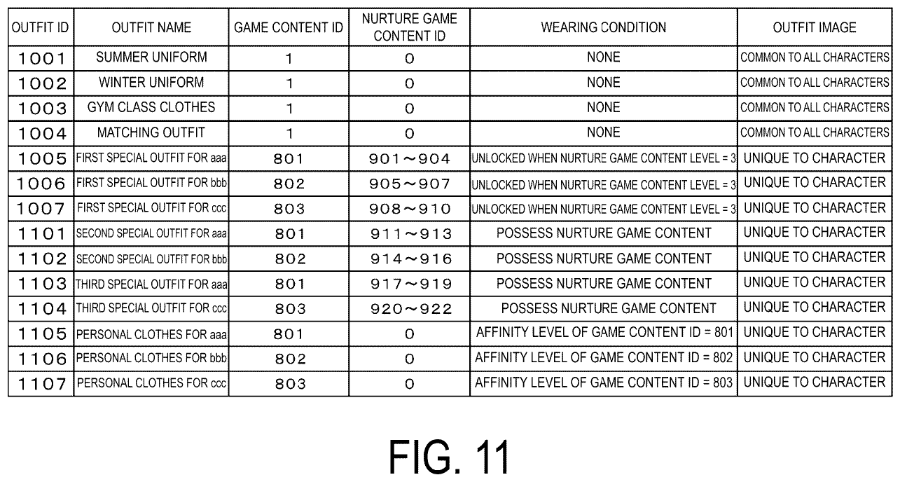

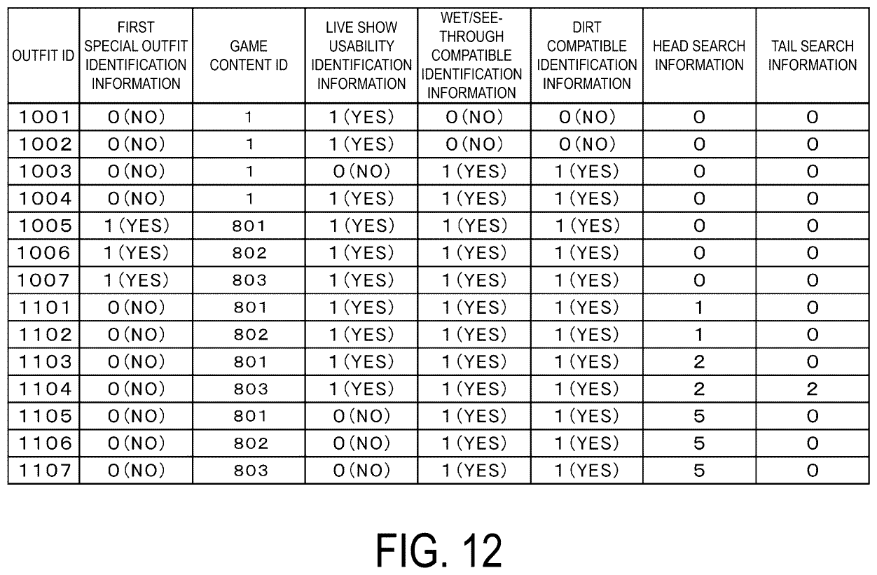

A second display area 162 is provided at the lower portion of the outfit selection dialog 160. The second display area 162 is an operation area for collectively setting the outfits in the provisionally selected state to a plurality of characters including the target character. In other words, the second display area 162 is an operation area in which the outfit selected by the player or an application range of the type of the outfit can be selected. A check box 162a and an applicable position selection portion 162b are provided in the second display area 162. The check box 162a receives an operation for setting whether the outfit in the provisionally selected state is applied to other characters. In other words, the check box 162a receives an operation for switching between enabling and disabling of the collective setting function of collectively setting the outfit in the provisionally selected state to a plurality of characters. Note that whether the collective setting is performed may be automatically switched using information described below using FIGS. 11 and 12.

In the vicinity of the check box 162a, a message saying that the collective setting function is enabled is displayed. Note that this message may differ depending on the type of outfit in the provisionally selected state, in other words, the outfit display type. The display type (kind) of the outfit worn by a character is roughly classified into a common display type in which a plurality of characters have a common appearance and an individual display type in which a plurality of characters have different appearances. Hereinafter, outfits classified into the common display type will be referred to as common outfits, and outfits classified into the individual display type will be referred to as individual outfits. The common outfits are outfits that can be set for all characters regardless of the type of the character. The common outfit has the same appearance in terms of decoration, color, and the like regardless of the type of the character wearing the outfit. The common outfit is, for example, a common school uniform.

The individual outfit is an outfit limited to a target character. In other words, the individual outfit can be set only to a predetermined character. In this case, only one character can be set with one individual outfit. The individual outfit may be, for example, an outfit for competition (hereinafter referred to as a “competition outfit”) designed only for a predetermined character for a specific race of the racing game. The individual outfit may be, for example, personal clothes provided for each character.

The outfit icon 132 is an icon obtained by deforming the model of the outfit to be worn by the character. Note that the outfit icon 132 may identify the outfit display type. For example, text such as uniform (common outfit), competition outfit, and personal clothes (individual outfit) may be displayed, or the common outfits and the individual outfit may have different icon colors. Further, the common outfit and the individual outfit may be tab-switched to display corresponding outfit icons. Hereinafter, as an example, the selection (provisional selection) of the outfit icon 132 will be described as the selection (provisional selection) of the display type.

When the common outfit is in the provisionally selected state, a message (in FIG. 7A, text saying “Also apply to other characters”) for explaining that the common outfit will be collectively set to other characters is provided in the vicinity of the check box 162a. Note that depending on the common outfit, collective setting may not be possible.

On the other hand, in the case where the individual outfit is in the provisionally selected state, as illustrated in FIG. 7B, a message (in FIG. 7B, text saying “Also apply competition outfit (default) to other characters”) explaining that the individual outfit in the provisionally selected state will be collectively set to other characters is provided in the vicinity of the check box 162a. As will be described in detail below, the individual display types (individual outfits) are further grouped into a plurality of special display types (special outfits). Depending on the special display type (special outfit), collective setting may not be possible.

When a special outfit (second special outfit and third special outfit to be described below) which cannot be collectively set are in the provisionally selected state, the second display area 162 is hidden as illustrated in FIG. 7D. Since the second display area 162 is hidden, the player cannot collectively set the special outfit in the provisionally selected state to a plurality of characters. In this example, the second display area 162 is not displayed when a special outfit that cannot be collectively set is in the provisionally selected state. However, in another example, the second display area 162 may be grayed out and displayed so as not to receive an operation of the player. Alternatively, although the second display area 162 is displayed, an operation on the check box 162a may be set to be unreceivable. In this case, for example, the display color of the second display area 162 may be different from the normal color.

Note that, for example, in a case where a plurality of individual outfits that can be collectively set are provided, as in the following modified example, a message explaining that the individual outfits in the provisionally selected state will be collectively set to other characters may be provided.

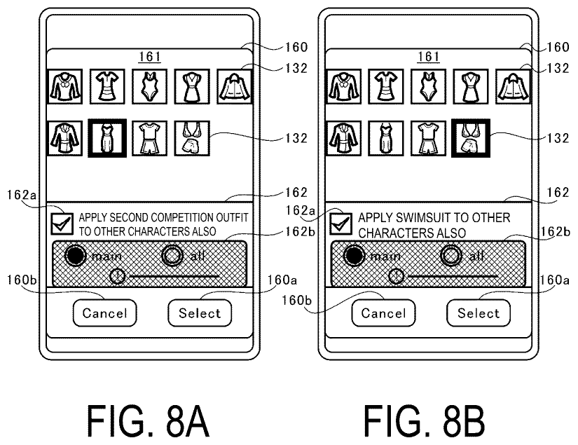

FIG. 8A is a first diagram for describing an example of an outfit selection dialog according to a modified example. FIG. 8B is a second diagram for describing an example of an outfit selection dialog according to a modified example. For example, it is assumed that a second special outfit and a swimsuit, which will be described below, are individual outfits that can be collectively set. In this case, for example, when the second special outfit is in the provisionally selected state, a message saying “Also apply second competition outfit to other characters” is suitably displayed in the vicinity of the check box 162a as illustrated in FIG. 8A. Also, for example, when the swimsuit is in the provisionally selected state, a message saying “Also apply swimsuit to other characters” is suitably displayed in the vicinity of the check box 162a as illustrated in FIG. 8B.

In this manner, since the message is displayed so that the type of outfit to be applied to other characters can be recognized, it is possible to prevent an erroneous operation by the player, and visibility and operability are enhanced. In addition, the occurrence of the erroneous operation is also suppressed by displaying different messages between the case of collectively setting the common outfit and the case of collectively setting the individual outfit. Furthermore, the player can cause a plurality of characters to efficiently wear various types of outfits that are different for each character.

At the start of display of the outfit selection dialog 160, the collective setting function is set to be disabled, and the check box 162a is displayed as illustrated in FIG. 7A. In this state, the applicable position selection portion 162b is displayed grayed out, and operation input to the applicable position selection portion 162b is disabled. When the check box 162a is tapped in the state illustrated in FIG. 7A, the collective setting function is set to be enabled. In this state, as illustrated in FIG. 7C, the check mark is highlighted in the check box 162a, and the applicable position selection portion 162b is normally displayed.

As illustrated in FIG. 7C, a partial character selection toggle 164a and an all character selection toggle 164b are provided in the applicable position selection portion 162b. The partial character selection toggle 164a and the all character selection toggle 164b can be alternatively selected. The partial character selection toggle 164a and the all character selection toggle 164b receive an operation of setting a range to which the outfit in the provisionally selected state is applied.

When the partial character selection toggle 164a is tapped, the outfit in the provisionally selected state is applied to some of the characters. Here, in a case where the target character is set to the main position, when the partial character selection toggle 164a is selected, the application range of the outfit in the provisionally selected state becomes all the characters set to the main position. In this case, in the vicinity of the partial character selection toggle 164a, “main” is displayed as illustrated in FIG. 7C to notify that the characters to which the outfit will be applied correspond to the characters set to the main position.

On the other hand, in a case where the target character is set to the back position, when the partial character selection toggle 164a is selected, the application range of the outfit in the provisionally selected state becomes all the characters set to the back position. In this case, “back” is displayed near the partial character selection toggle 164a. In this manner, it is notified that the characters to which the outfit will be applied correspond to the characters set to the back position.

When the select button 160a is tapped in a state where the check box 162a and the partial character selection toggle 164a are selected, the outfit in the provisionally selected state is collectively set to some of the characters. Specifically, when the target character is set to the main position, the outfit in the provisionally selected state is collectively set to all the characters set to the main position. When the target character is set to the back position, the outfit in the provisionally selected state is collectively set to all the characters set to the back position.

Here, it is assumed that the select button 160a is tapped in a state where the all character selection toggle 164b is selected. In this case, the outfit in the provisionally selected state is collectively set to all characters regardless of the position type. That is, when the all character selection toggle 164b is selected, the outfit in the provisionally selected state is set to all the characters regardless of whether the target character is set to the main position or the back position.

As will be described in detail below, outfits are classified into a plurality of groups, and the characters that can wear the outfits classified into a predetermined group are restricted. In the second display area 162, a message saying that the characters that can wear the outfits may be restricted is displayed. Specifically, for example, a message such as “This does not apply to characters without a competition outfit” is displayed. Further, the outfits include a special outfit unique to the character currently set as the target character. Here, a first special outfit, a second special outfit, and a third special outfit are provided as the special outfits.

The first special outfit is provided to all characters and can be worn by the characters when a wearing condition is satisfied. The wearing condition for the first special outfit is common to all characters. However, the wearing condition may be different depending on the character. In the present embodiment, the first special outfit is an outfit unique to the character appearing in the nurture game. In the nurture game, a race in which the nurture target character competes against other characters is executed. The first special outfit is a so-called competition outfit worn by the character in the nurture game. Note that the appearance of the first special outfit differs for each character. Only one first special outfit may be provided for each character, or a plurality of first special outfits may be provided for each character. In addition, a grade may be provided for a race of the nurture game, and the first special outfit may be wearable only in a race with a high grade.

On the other hand, the second special outfit and the third special outfit are outfits provided to only some of the characters. The second special outfit and the third special outfit can be set to the target character in a case where the wearing condition is satisfied. The second special outfit and the third special outfit are outfits outside the application range of the collective setting function. In other words, the second special outfit and the third special outfit cannot be collectively set to a plurality of characters. Thus, when the second special outfit or the third special outfit is in the provisionally selected state, the second display area 162 is hidden as illustrated in FIG. 7D. However, the collective setting function may also be applied as described above to the second special outfit and the third special outfit.

As described above, the outfit selection dialog 160 includes the first display area 161 and the second display area 162. The first display area 161 is an area in which the display type of the appearance of the character (outfit worn by the character) can be selected, and a common display type in which the appearances of a plurality of characters are in common or a special display type in which the appearances of a plurality of characters are different can be selected. The second display area 162 is an area in which the application range of the display type selected by the player can be selected, and a predetermined character or a plurality of characters can be selected as the application range.

Specifically, by unchecking the check box 162a, the player can set the application range of the outfit to only a predetermined character. Here, the predetermined character is a character selected by the player. On the other hand, the player can set the application range of the outfit to a plurality of characters including a predetermined character by checking the check box 162a.

In the outfit selection dialog 160, the display of the second display area 162 changes depending on the selected display type, that is, outfit. Specifically, the second display area 162 is displayed when an outfit with the collective setting function enabled is in the provisionally selected state, whereas the second display area 162 is hidden when an outfit with the collective setting function disabled is in the provisionally selected state. Thus, it is possible to notify the player that collective setting is impossible. The types of outfits will be described in detail below.

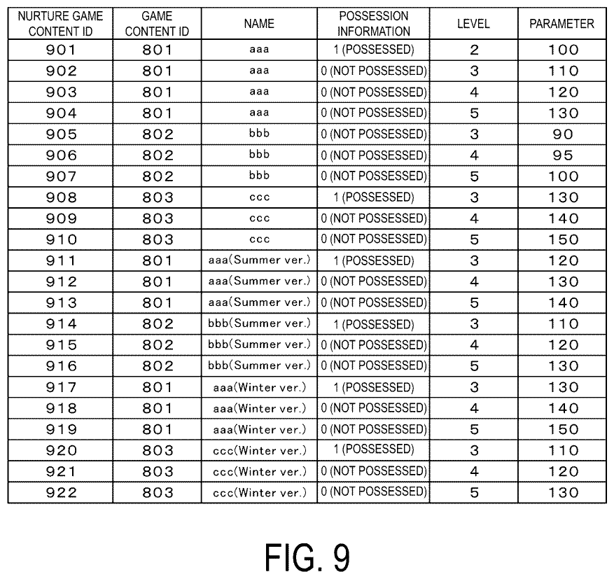

FIG. 9 is a diagram for describing information relating to a character. As illustrated in FIG. 9, the game content ID, name, possession information, level, and parameter are associated with the nurture game content ID. As described above, the player can possess nurture game contents provided by the administrator. Each of the nurture game contents is associated with a nurture game content ID. Since the nurture game content ID is unique to the nurture game content, the nurture game content ID can be considered to be the type of the nurture game content. As described above, a game content ID unique to the character is always set in the nurture game content (nurture game content ID). Since the game content ID is unique to the character, the game content ID can be considered to be the type of the character. In the present embodiment, the nurture game content ID and the game content ID are both represented by a three digit decimal integer.

One game content ID is always associated with a nurture game content ID, and thus one character is set for each nurture game content. In addition, in FIG. 9, four nurture game contents to which nurture game content IDs 901 to 904 are assigned are classified into groups of the same type. The game content ID and name associated with the nurture game content classified into the same group type are the same, but the level and parameter are different. As described above, a plurality of nurture game contents classified into the same group type are set such that higher the level, the more advantageous the parameter used in the nurture game.

Here, the same group type refers to a collection of the same characters at different levels managed by different IDs. It is obvious that the configuration is not limited to this configuration, and the same character (nurture game content of the same character) may be managed with the same ID, and only the associated data may be changed. Although details of the parameter are omitted, the parameter is the performance or ability of the character, for example, and is a numerical value for speed, stamina, or ability that can be activated during the game.

In the example illustrated in FIG. 9, three nurture game contents assigned with nurture game content IDs 905 to 907, three nurture game contents assigned with nurture game content IDs 908 to 910, three nurture game contents assigned with nurture game content IDs 911 to 913, three nurture game contents assigned with nurture game content IDs 914 to 916, three nurture game contents assigned with nurture game content IDs 917 to 919, and three nurture game contents assigned with nurture game content IDs 920 to 922 are classified into groups of the same type.

Note that the four nurture game contents to which nurture game content IDs 901 to 904 are assigned, the three nurture game contents to which nurture game content IDs 911 to 913 are assigned, and the three nurture game contents to which nurture game content IDs 917 to 919 are assigned are different in type from each other and are associated with different names. However, the nurture game content classified into these three types are associated with a common game content ID. In this manner, some game content IDs, that is, some characters, each are associated with a plurality of types of the nurture game content.

Specifically, for example, 901 to 904 are level differences of the character aaa of the normal version, 911 to 913 are level differences of the character aaa of a special version which can be obtained by a lottery in a summer limited-time event, and 917 to 919 are level differences of the character aaa of a special version which can be obtained by a lottery in the winter limited-time event. In the possession information, whether the character is possessed and at what level the character is are managed. In addition, although FIG. 9 includes unpossessed nurture game content, only possessed nurture game content may be managed.

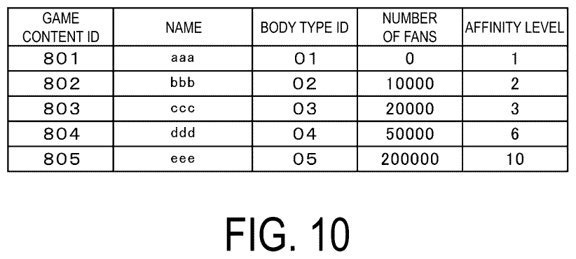

FIG. 10 is a diagram for describing information associated with the game content ID. As illustrated in FIG. 10, the game content ID is associated with the name, body type ID, parameter of the number of fans, and affinity level parameter. Basically, only one appearance of the character itself, that is, only one figure and shape of the character body excluding an outfit and the like is set for one game content ID. The body type ID associated with the game content ID is associated with information when the character is displayed on the game screen, such as the height of the character body.

Thus, for example, as illustrated in FIG. 9, the figures and shapes of the character bodies associated with the nurture game content having nurture game content IDs 901 to 904, 911 to 913, and 917 to 919 are the same. In addition, in a case where the type (group) of the nurture game content is the same, the outfit worn by the characters are the same. Thus, for example, in the nurture game content having nurture game content IDs 901 to 904, the figure and shape of the displayed character body and the outfit worn by the character are the same, and there is no difference in appearance.

On the other hand, even in a case where the game content ID is the same, but the type of the nurture game content is different, the appearance of the outfit or the like of the character is different. For example, three nurture game contents having nurture game content IDs 901, 911, and 917 all have the same character body, but outfits that the character is wearing are different.

In the player terminal 1 and the server 1000, player information is stored in association with the player ID. The player information includes possession information of the nurture game content. Specifically, possession information of “1” indicating possession or “0” indicating non-possession is stored in association with the nurture game content ID. As described above, the player can strengthen their possessed nurture game content. When the possessed nurture game content is strengthened, the possession information of the nurture game content having the same type as the possessed nurture game content before strengthening but having a higher level is updated to “1”.

Although detailed description is omitted, when a predetermined condition is satisfied in the nurture game, the nurture target character obtains a fan. As illustrated in FIG. 10, when the nurture target character obtains a fan, the number of fans associated with the game content ID of the nurture target character is updated. Further, as described above, the player can cause the nurtured character nurtured in the nurture game to participate in the team competition race. The nurtured character obtains a fan on the basis of the result of the team competition race. A game content ID is associated with the nurtured character, and when the nurtured character obtains a fan, the number of fans associated with the game content ID of the nurtured character is updated.

The affinity level is a parameter set for the character and is managed in association with the game content ID. Specifically, for example, the affinity level parameter is a parameter representing how much a common character (game content) has been used across the entire game. By frequently using the same character in the nurture function and the battle function, the degree of accumulation of the affinity level parameter changes to generate a benefit or a bonus for the player. In the present embodiment, by using the affinity level parameter, the player's feelings toward the character are increased. This can have the effect of increasing the play frequency of the entire game. In addition, the affinity level parameter is managed per character in association with the game content ID. In addition, for example, the affinity level parameter may be a usage parameter of a character (game content) in a specific game function (for example, a race) among a plurality of game functions. This allows the player to know the use frequency of a specific character in a specific game. This can more effectively motivate the player to be more detailed.

As information related to the affinity level parameter, an affinity level rank may exist for each character. The affinity level rank is nurtured when the accumulated amount of the affinity level parameter satisfies a condition determined for each rank. For example, rank 0 to rank 10 are set as the affinity level rank at the beginning of the operation of the game, and the upper limit of the affinity level rank may be unlocked in accordance with the operation period of the game. The affinity level parameter is granted to the used character when a condition is achieved in the nurture function, the battle function, or the like. The amount of increase in the parameter of the affinity level based on the use of the game function may be changed depending on the game result (evaluation, ranking, or the like). When the affinity level rank reaches a predetermined rank by accumulating the affinity level parameter, the story which is the content associated with the character whose affinity level rank has reached the predetermined rank is unlocked. The affinity level rank serving as the unlock condition of the story may be the same for each character or may be different for each character.

FIG. 11 is a diagram for describing outfit IDs. Outfits that can be worn by the character in the live show performance, that is, outfits that can be selected in the outfit selection dialog 160 are associated with an outfit ID. In the present embodiment, the outfit ID is represented by a four digit decimal integer. As described above, outfits that can be set for a character in the live show performance are classified into common outfits and individual outfits. The common outfits are outfit that can be set for all characters regardless of the type of the character, that is, the game content ID. The common outfit has the same design, that is, appearance in terms of decoration, color, and the like, regardless of the type of the character wearing the outfit. However, a body type such as a height is set for each character, and the size of the outfit varies depending on the body type of the character wearing the outfit. Thus, in the present embodiment, the design of the common outfit other than the size is common to a plurality of characters.

Here, four types of outfits having outfit IDs 1001, 1002, 1003, and 1004 are provided as common outfits. As an example, the outfit having outfit ID 1001 is a summer uniform, the outfit having outfit ID 1002 is a winter uniform, the outfit having outfit ID 1003 is gym class clothes, and the outfit having outfit ID 1004 is a matching outfit such as a dress with a predetermined decoration. The common outfits are not provided with a wearing condition and can be set for all characters. That is, the target characters to which the common outfits can be set correspond to all of the characters. In the live show performance, the same outfit image is applied to the characters to which the common outfit is set.

A character that does not wear a common outfit may be provided. For example, a first common outfit that can be worn by all of the characters and a second common outfit that cannot be worn by a specific character such as an NPC that cannot be nurtured by the player (that is not nurture game content) may be provided in the nurture game content.

The outfit ID is associated with a game content ID and a nurture game content ID as information indicating a target character to which the outfit can be set. The common outfit is associated with “1” as the game content ID and “0” as the nurture game content ID. “1” of the game content ID is information indicating all game content, and “0” of the nurture game content ID is information indicating all nurture game content. As described above, in a case where a character that does not wear a common outfit is provided, specifically, for example, a plurality of common outfits may be provided such that “1” is a first common outfit that can be worn by all in the nurture game content and “2” is a second common outfit that cannot be worn by a specific character such as an NPC that cannot be nurtured by the player (not nurture game content).

On the other hand, the individual outfit is an outfit limited to a target character. In other words, the individual outfit can be set only to a character with a predetermined game content ID. In other words, only one game content ID of the target character is associated with the outfit ID of the individual outfit. For example, game content ID 801 is associated with the individual outfit having outfit ID 1005, and an individual outfit having outfit ID 1006 is associated with game content ID 802. In this manner, the individual outfit is an outfit unique to a character. In the live show performance, an outfit image provided for each outfit ID of the individual outfit is applied. As a method of applying the outfit image, a general two-dimensional or three-dimensional method is used. Specifically, for example, in the case of a two-dimensional image, the entire image may be changed depending on an outfit, or in the case of a three-dimensional image, rendering may be performed by combining a 3D model of an outfit with a 3D model of a basic character body shape.

Here, in the present embodiment, the individual outfits are classified into any of a plurality of groups. For example, in the present embodiment, a first special outfit group, a second special outfit group, a third special outfit group, and a personal clothes group are provided. Hereinafter, an individual outfit classified into the first special outfit group will be referred to as a first special outfit, an individual outfit classified into the second special outfit group will be referred to as a second special outfit, an individual outfit classified into the third special outfit group will be referred to as a third special outfit, and an individual outfit classified into the personal clothes group will be referred to as personal clothes.

The first special outfits are provided for all characters associated with the nurture game content, in other words, all characters that can be possessed by the player. That is, the same number of first special outfits as the number of game content IDs are provided. However, the first special outfit may be provided for some of the characters that can be possessed. Although only three outfit IDs 1005 to 1007 of the first special outfits are illustrated in FIG. 11, actually, the number of outfit IDs of the first special outfit is equal to the number of characters that can be possessed, that is, the number of game content IDs.

A wearing condition is set for the first special outfit. In the present embodiment, when the level of at least one nurture game content associated with the game content ID of the target character becomes 3 or more, the first special outfit is made settable to the target character. Thus, the wearing condition of the first special outfit can be considered to include possession of at least one piece of nurture game content associated with the game content ID of the target character. Although it is possible to raise the level by accumulating a certain number of items that can be obtained in games, events, and lotteries, the method of raising the level is not limited to this.

Note that, in this example, the nurture game content for which the wearing condition is to be determined corresponds to all of the nurture game contents associated with the game content ID of the target character. However, the nurture game content for which the wearing condition is to be determined may be any one of the nurture game contents associated with the game content ID of the target character. For example, the nurture game content for which the wearing condition of the first special outfit is to be determined may be a nurture game content that is first provided among the nurture game contents associated with the game content ID of the target character. With such a configuration, the processing is simplified and the load on the system can be reduced.

In this manner, different outfit IDs are set to the first special outfit classified into the first special outfit group. Thus, the outfit image, that is, the design, of the first special outfit displayed in the live show performance is different for each character. Here, it is assumed that the designs of all the first special outfits are different from each other. However, the design of some or all of the first special outfits may be the same, and for example, only the color may be different. In any case, it is only necessary that the player can recognize that the outfit images of the first special outfits are different in appearance from each other.

Further, the second special outfits are provided for some of the characters associated with the nurture game content, in other words, some of the characters that can be possessed by the player. Specifically, for example, the second special outfit is a swimsuit outfit and is set for characters picked up in a summer limited-time event every year. However, the second special outfit may be provided for all the characters that can be possessed. In the example illustrated in FIG. 11, two second special outfits having outfits IDs 1101 and 1102 are provided.

A wearing condition is set for the second special outfit. In the present embodiment, as the wearing condition for the second special outfit, possession of a predetermined nurture game content associated with the game content ID of the target character is set. For example, the wearing condition of the second special outfit to which outfit ID 1101 is set is to possess the nurture game content having nurture game content IDs 911 to 913.

Specifically, for example, the second special outfit to which outfit ID 1101 is set is a swimsuit outfit worn by character aaa which is a special version that can be obtained via a gacha lottery for the nurture game content having nurture game content IDs 911 to 913. It is obvious that even though swimsuit outfits of the nurture game content can be obtained in the same summer limited-time event, these special outfits have different designs. The wearing condition for the second special outfit is not limited to this. For example, the wearing condition may include that the level of the nurture game content required to be possessed is equal to or higher than a predetermined level.

Further, the third special outfits are provided for some of the characters associated with the nurture game content, in other words, some of the characters that can be possessed by the player. Specifically, for example, the third special outfit is a Christmas-themed outfit (the likeness of Santa or a reindeer), and is set to a character picked up in a winter limited-time event every year. However, the third special outfit may be provided for all the characters that can be possessed. In the example illustrated in FIG. 11, two third special outfits having outfits IDs 1103 and 1104 are provided.

A wearing condition is set for the third special outfit. In the present embodiment, as the wearing condition for the third special outfit, possession of a predetermined nurture game content associated with the game content ID of the target character is set. For example, the wearing condition of the third special outfit to which outfit ID 1104 is set is to possess the nurture game content having nurture game content IDs 920 to 922.

For example, the third special outfit to which outfit ID 1103 is set is an outfit like Santa Clause worn by character aaa, which is a special version that can be obtained via a gacha lottery in the winter limited-time event. It is obvious that even though Christmas-themed outfits of the nurture game content can be obtained in the same winter limited-time event, these special outfits have different designs. The wearing condition for the third special outfit is not limited to this. For example, the wearing condition may include that the level of the nurture game content required to be possessed is equal to or higher than a predetermined level.

The personal clothes are provided for all characters associated with the nurture game content, in other words, all characters that can be possessed by the player. That is, the same number of personal clothes as the number of game content IDs are provided. However, the personal clothes may be provided for some of the characters that can be possessed. Although only the outfit IDs of three personal clothes are illustrated in FIG. 11, actually, the number of outfit IDs of the personal clothes is equal to the number of characters that can be possessed, that is, the number of game content IDs.

A wearing condition is set for the personal clothes. In the present embodiment, as the wearing condition for the personal clothes, it is set that the affinity level of the target character, that is, the affinity level of the game content ID associated with the outfit ID is equal to or greater than a predetermined value. Setting the affinity level, which is a parameter indicating the use frequency of a specific character in the game, as a wearing condition (outfit unlock condition) can have the effect of efficiently enhancing the affinity level parameter (character common parameter) while motivating the player to play a main game function such as racing or training and giving further enjoyment to the player. As a result, it is possible to further enhance the feelings toward the character who has satisfied the wearing condition. Furthermore, it is possible to make all the characters that the player has strong feelings toward (that has unlocked the personal clothes by increasing the affinity level) wear personal clothes all at once, thereby giving further enjoyment to the player. However, the wearing condition of the personal clothes is not limited thereto, and for example, the same wearing condition as that of other individual outfits may be set. In FIG. 11, the wearing condition of an outfit is indicated, but this may be replaced with another condition such as a possession condition, an obtaining condition, or an unlock condition for the outfit.

FIG. 12 is a diagram for describing information associated with outfit IDs. An information table is stored in the player terminal 1 and the server 1000. In the information table, various types of information illustrated in FIG. 12 are associated with outfit IDs. In the player terminal 1, the image images 126 and 130 to be displayed on the live show preparation screen 120 and the image of the character to be displayed on the live show video are generated with reference to the information table. In the information table, the outfit ID is associated with first special outfit identification information, game content IDs, live show usability identification information, wet/see-through compatible identification information, dirt compatible identification information, head search information, and tail search information. Although FIG. 12 is described as an independent table, it may be managed as the same table as in FIGS. 11, 13, and 14. At this time, redundant data may be omitted, or the head ID, the tail ID, and images thereof may be incorporated into the head and tail search information.

The first special outfit identification information is information for identifying whether the outfit associated with the outfit ID is the first special outfit. The first special outfit identification information includes “0” for indicating that it is not the first special outfit and “1” indicating that it is the first special outfit. In the information table, the first special outfit identification information of “1” is associated with the outfit ID of the first special outfit. Note that here, the identification information of only the first special outfit will be described, but no such limitation is intended. Specifically, for example, by using the column name as outfit identification information, information of “2” for the second special outfit, “3” for the third special outfit, “4” for the personal clothes, “5” for any player setting, and “6” for outfits not collectively set is allocated, and by selecting the outfit type, the display of the second display area 162 is changed, and a special outfit corresponding to each outfit type may be put on each character.

In the information table, the outfit ID is associated with the game content ID of the target character. The outfit ID of the common outfit is associated with “1” as the game content ID. The live show usability identification information is information for identifying whether the outfit associated with the outfit ID is usable in a live show performance. The live show usability identification information includes “0” for indicating that the outfit is not usable in a live show performance and “1” for indicating that the outfit is usable in a live show performance. Here, gym class clothes and personal clothes are set to be unusable in a live show performance, and the other outfits are set to be usable. However, no such limitation is intended, and for example, personal clothes may be set to “1”.

The wet/see-through compatible identification information is information for identifying whether the outfit associated with the outfit ID is an outfit compatible with being wet/see-through. Note that the wet/see-through function is a function of making a worn outfit see-through when the character is displayed in a rainy scene in a video of a race or a live show, for example. The wet/see-through compatible identification information includes “0” for indicating that the outfit is not wet/see-through compatible and “1” for indicating that the outfit is wet/see-through compatible. Here, the summer uniform and the winter uniform are set so as not to be not wet/see-through compatible, and the other outfits are set so as to be wet/see-through compatible.

The dirt compatible identification information is information for identifying whether the outfit associated with the outfit ID is an outfit compatible with being dirty. Note that the dirt function is a function of making a worn outfit dirty when the character is displayed in a muddy or similar dirty environment in a video of a race or a live show, for example. The dirt compatible identification information includes “0” for indicating that the outfit is not dirt compatible and “1” for indicating that the outfit is dirt compatible. Here, the summer uniform and the winter uniform are set so as not to be not dirt compatible, and the other outfits are set so as to be dirt compatible.

The head search information is information for identifying a head image when the character is displayed after the outfit is set. When an outfit is set for each character, head search information is identified from the outfit ID. Then, the head image of the character to be displayed on the game screen is extracted on the basis of the head search information.

Similarly, the tail search information is information for identifying a tail image when the character is displayed after the outfit is set. When an outfit is set for each character, tail search information is identified from the outfit ID. Then, the tail image of the character to be displayed on the game screen is extracted on the basis of the tail search information.

Note that the head search information and the tail search information are each have a value of one decimal digit. The head search information of “0” is associated with the outfit IDs of the outfits classified into the common outfit group and the first special outfit group. Further, head search information having a value set for each group is associated with the outfit IDs of the outfits classified into a group other than the first special outfit group.

In addition, tail search information of “2” is associated with some of the outfit IDs (here, 1104) of the individual outfits, and tail search information of “0” is associated with the other outfit IDs.

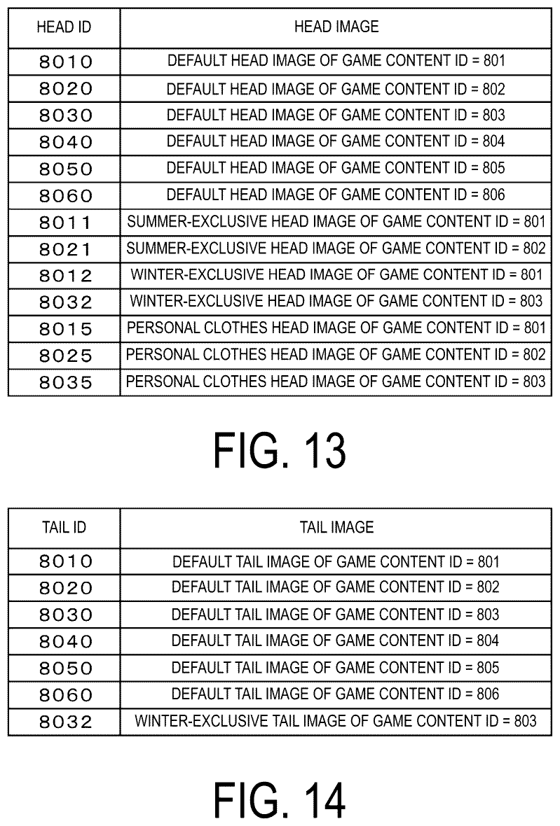

FIG. 13 is a diagram for describing head IDs. A head image identifying table is stored in the player terminal 1 and the server 1000. The head image identifying table is a table for identifying a head image to be displayed on the game screen. In the head image identifying table, one head image is associated with each head ID. Here, the head IDs are provided in the same number as the outfit IDs of the individual outfits. In addition, the head ID has a four-digit value obtained by adding the head search information to the three-digit game content ID. The head ID is associated with a head image of a character corresponding to the game content ID of the first three digits.

For example, a default head image of a character having game content ID 801 is associated with head ID 8010. Further, for example, a default head image of a character having game content ID 806 is associated with head ID 8060. In this manner, the default head image of the target character is associated with the head ID having “0” at the end.

For example, a summer-exclusive head image of a character having game content ID 801 is associated with head ID 8011. For example, a winter-exclusive head image of a character having game content ID 803 is associated with head ID 8032. In this manner, the head image of the target character corresponding to the individual outfit is associated with the head ID that ends in a value other than “0”.

When the outfit is set by the player, the outfit ID is set in association with the game content ID set with the outfit. When the outfit ID is set, the head ID is identified from the game content ID associated with the outfit ID and the head search information. When the head ID is identified in this manner, the head image associated with the identified head ID is read out with reference to the head image identifying table, and the character is displayed.

According to the head image identifying table illustrated in FIG. 13, when the common outfit and the first special outfit are set, the default head image is used. On the other hand, the head ID with the last one digit value corresponding to a value other than “0” indicating an individual outfit group other than the first special outfit group is associated with a dedicated head image of the target character. Thus, when the outfit is set to the second special outfit, the third special outfit, or the personal clothes, the dedicated head image corresponding to the outfit is identified.

Specifically, when an individual outfit other than the first special outfit is set, a dedicated head image prepared according to the individual outfit other than the default is used. The dedicated head image is different from the default head image in terms of, for example, the facial expression of the character, the hairstyle of the character, or other decorations for the head such as a hair ornament.

FIG. 14 is a diagram for describing tail IDs. A tail image identifying table is stored in the player terminal 1 and the server 1000. The tail image identifying table is a table for identifying a tail image to be displayed on the game screen. In the tail image identifying table, one tail image is associated with each tail ID. In the present embodiment, a tail ID having the same value as the head ID identified when the first special outfit is selected is provided. In addition, tail ID 8032 is provided which is identified when outfit ID 1104, which is the third special outfit, is selected.

The tail ID has a four-digit value obtained by adding the tail search information to the three-digit game content ID. The tail ID is associated with a default tail image of a character corresponding to the game content ID of the first three digits.

For example, a default tail image of a character having game content ID 801 is associated with tail ID 8010. Further, for example, a default tail image of a character having game content ID 806 is associated with tail ID 8060. In this manner, the default tail image of the target character is associated with the tail ID having “0” at the end.

For example, a winter-exclusive tail image of a character having game content ID 803 is associated with tail ID 8032. In this manner, the tail image of the target character corresponding to the individual outfit is associated with the tail ID that ends in a value other than “0”.

When the outfit ID is set, the tail ID is identified from the game content ID associated with the outfit ID and the tail search information. When the tail ID is identified in this manner, the tail image associated with the identified tail ID is read out with reference to the tail image identifying table, and the character is displayed.

According to the tail image identifying table illustrated in FIG. 14, a dedicated tail image is identified only when the third special outfit is set to the character having game content ID 803. On the other hand, when another outfit is set, the default tail image is used. The dedicated tail image is different from the default tail image in terms of, for example, the shape of the tail of the character and the ornament attached to the tail. By dividing the images into head and tail images, the default can be set to “0” in principle, and the image can be invoked only when necessary. This can make the processing more efficient. Although the outfits are separated by head and tail, an image or a 3D model including all of them may be used.

As described above, in the present embodiment, the head image and the tail image of the character are identified in accordance with the outfit set for the character. Although detailed description is omitted, the player terminal 1 and the server 1000 are provided with an outfit image identifying table. In the outfit image identifying table, outfit images are associated with respective outfit IDs. When an outfit ID is set, an outfit image associated with the set outfit ID is identified with reference to the outfit image identifying table. By combining the outfit image, the head image, and the tail image identified in this manner, the image images 126 and 130 and the character image displayed in the live show video are generated.

Here, as described above, the player can set a character and an outfit to be worn by the character for each position number on the live show preparation screen 120. At this time, the player can individually set a character and outfit for each position number. On the other hand, since the operation of setting characters and outfits for a large number of positions is very troublesome, the collective setting function is provided for outfits as described above. A flow of processing of identifying an outfit ID when the collective setting function is used will be described below.

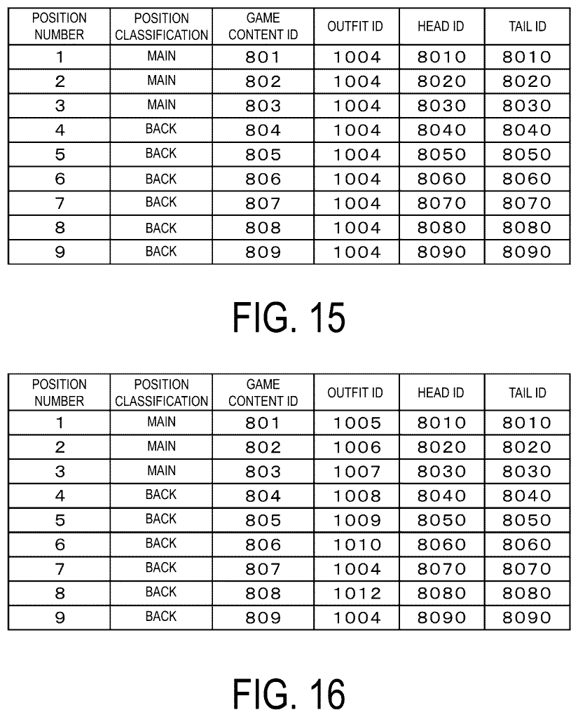

FIG. 15 is a diagram for describing a common outfit being set using the collective setting function. For example, as illustrated in FIG. 15, it is assumed that nine positions are set for a selected music piece. Here, position numbers 1 to 3 are the main positions, and position numbers 4 to 9 are the back positions. Although a character corresponding to a music piece set in advance or a randomly selected character may be arranged at each position, here, it is assumed that a character having the game content ID “80N (N is an integer from 1 to 9)” is set at position number N (N is an integer from 1 to 9).

In the above state, it is assumed that any character, that is, any position number is selected, and a matching outfit having outfit ID 1004 is selected in the outfit selection dialog 160. When the select button 160a is tapped in a state where the all character selection toggle 164b is selected, outfit ID 1004 is set to all of the position numbers. When the outfit ID is set, the head ID and the tail ID identified as described above are set for all of the position numbers.

An image of the character corresponding to the position number is generated on the basis of the outfit ID, the head ID, and the tail ID set in this manner. Accordingly, in the example illustrated in FIG. 15, all of nine characters collectively wear the matching outfit.

For example, it is assumed that the select button 160a is tapped in a state where position number 1 is selected and the partial character selection toggle 164a is selected. In this case, outfit ID 1004 is set for position numbers 1 to 3, and the head ID and the tail ID corresponding to the game content ID are set. At this time, the outfit ID, the head ID, and the tail ID are not updated for position numbers 4 to 9.

In a similar manner, for example, it is assumed that the select button 160a is tapped in a state where position number 9 is selected and the partial character selection toggle 164a is selected. In this case, outfit ID 1004 is set for position numbers 4 to 9, and the head ID and the tail ID corresponding to the game content ID are set. At this time, the outfit ID, the head ID, and the tail ID are not updated for position numbers 1 to 3.

In this manner, in the present embodiment, a common outfit can be collectively set for a plurality of characters. This allows operability and efficiency to be enhanced. In addition, since the range of collective setting of the common outfit can be limited to some of the positions, the number of variations for outfits to be worn is increased, and the operability and efficiency are further enhanced. However, when the common outfit is collectively set, the outfit of all characters included in the range of the collective setting is the same. Thus, in the present embodiment, the first special outfit among the individual outfits that are outfits unique to the character is also a target of the outfit collective setting function.

FIG. 16 is a diagram for describing an individual outfit being set using the collective setting function. In the example illustrated in FIG. 16, the selected music piece and the characters set to each position number are the same as those in the example illustrated in FIG. 15. For example, it is assumed that position number 1 is selected and the first special outfit having outfit ID 1005 is selected in the outfit selection dialog 160. Also, it is assumed that the select button 160a is tapped in a state where the all character selection toggle 164b is selected.

In this case, the following processing is executed for each position number. Specifically, the possessed nurture game content associated with the game content ID set to the position number to be processed is extracted. Then, it is determined whether the level of the extracted possessed nurture game content is equal to or greater than a predetermined level, that is, whether the wearing condition is satisfied. As another example, instead of determining the wearing condition every time, by adding a special outfit unlocked state column in FIGS. 11 and 12 in which “0” is set when the wearing condition is not satisfied and “1” is set when the wearing condition is already satisfied (in other words, when the special outfit is unlocked and possessed by the player), determination can be made without referring to another information table.

When the wearing condition is satisfied, with reference to the information table (FIG. 12), an outfit ID associated with the game content ID set to the position number to be processed and having a “1” for the first special outfit identification information is set. For example, when the position number to be processed is “2”, it is determined whether the possessed nurture game content associated with game content ID 802 satisfies the wearing condition. When the wearing condition is satisfied, outfit ID 1006 identified on the basis of the information table is set.

On the other hand, when the wearing condition is not satisfied, a predetermined outfit ID is set. In the example illustrated in FIG. 16, characters with 7th and 9th position numbers do not satisfy the wearing condition. In this example, a matching outfit having outfit ID 1004, which is a common outfit, is set for the characters that do not satisfy the wearing condition. For a character that does not satisfy the wearing condition, a wearable outfit may be randomly set, or the character may be put in an unset state without any outfit set. Further, for example, when there is another wearable individual outfit, one of the individual outfits may be set, and when there are no other wearable individual outfits, one of the common outfits may be set.

When the first special outfit is collectively set, the application range can be limited to the main position or the back position as in the case of collectively setting the common outfit. In this case, the above-described processing is executed only for the position numbers in the set range. Further, although collective setting is possible only for the first special outfit among the individual outfits, collective setting may also be possible for other individual outfits.

As illustrated in FIG. 16, when the first special outfit is collectively set, different outfit IDs are set to each position number. Since the outfit image is identified on the basis of the set outfit ID, the individual outfits having different appearances are collectively worn by a plurality of characters. In this manner, according to the present embodiment, since individual outfits having different appearances can be collectively set for a plurality of characters, a wide variety of performances can be performed while enhancing operability, which enhances the enjoyment of the game.

### Functional Configuration and Control Processing in Player Terminal 1

Next, the functional configuration and the control processing in the player terminal 1 for executing the above-described game will be described. In the following description, among the functional configurations and control processing related to the live show performance, particularly those related to the collective setting function will be described in detail, and description of other configurations and control processing will be omitted.

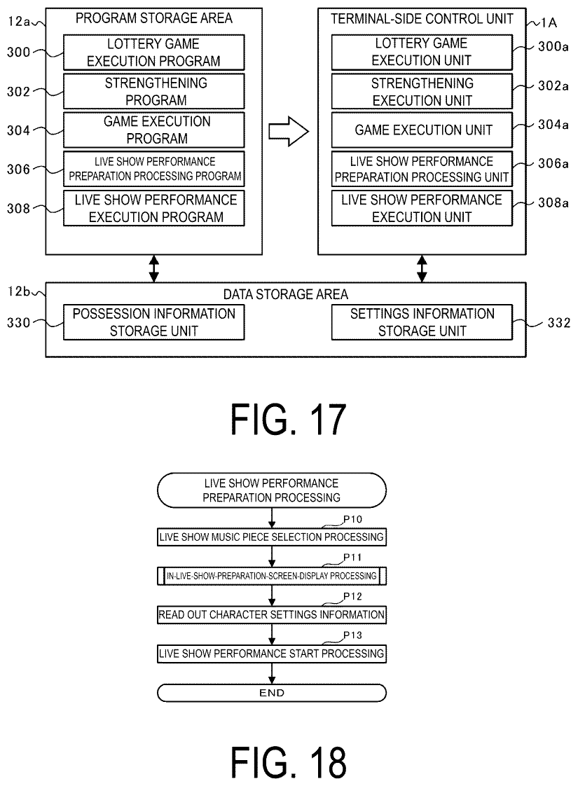

FIG. 17 is a diagram for describing the configuration of the memory 12 in the player terminal 1 and the function as a computer. The memory 12 is provided with a program storage area 12a and a data storage area 12b. When the application is activated, the CPU 10 stores the terminal-side control program (module) in the program storage area 12a.

The terminal-side control program includes a lottery game execution program 300, a strengthening program 302, a game execution program 304, a live show performance preparation processing program 306, and a live show performance execution program 308. The above-described programs are merely examples, and many other programs are also provided in the program storage area 12a.

In the data storage area 12b, a possession information storage unit 330 and a settings information storage unit 332 are provided as storage units for storing data. The possession information storage unit 330 stores possessed nurture game content and information indicating the possessed characters. The possession information storage unit 330 stores information indicating possession or non-possession of nurture game contents, information indicating the level of the nurture game contents, and information indicating the affinity level of game contents (character). The settings information storage unit 332 stores information relating to characters appearing in a live show performance and outfits. Note that the above-described storage units are merely examples, and many other storage units may be provided in the data storage area 12b. The storage unit is provided with multiple tables.

The CPU 10 operates each program stored in the program storage area 12a and updates the data in each storage unit of the data storage area 12b. Then, the CPU 10 causes the player terminal 1 (computer) to function as a terminal-side control unit 1A by operating each program stored in the program storage area 12a. The terminal-side control unit 1A includes a lottery game execution unit 300a, a strengthening execution unit 302a, a game execution unit 304a, a live show performance preparation processing unit 306a, and a live show performance execution unit 308a.

Specifically, the CPU 10 operates the lottery game execution program 300 to cause the computer to function as the lottery game execution unit 300a. Similarly, the CPU 10 operates the strengthening program 302, the game execution program 304, the live show performance preparation processing program 306, and the live show performance execution program 308 to cause the computer to function as the strengthening execution unit 302a, the game execution unit 304a, the live show performance preparation processing unit 306a, and the live show performance execution unit 308a.

When a lottery request operation requesting execution of a lottery is input while the lottery screen is displayed, the lottery game execution unit 300a executes lottery request processing. In the lottery request processing, lottery request information is transmitted to the server 1000. When the lottery request information is received, the server 1000 executes lottery processing of determining a nurture game content by a lottery.

The nurture game content determined in the lottery processing is stored in the storage unit 1018 of the server 1000 in association with the player ID. When a nurture game content not possessed by the player is determined, the nurture game content possession information is updated to “possessed” in the server 1000. Further, the server 1000 causes the player terminal 1 to receive lottery result information indicating a result of the lottery.

When the lottery result information is received, the lottery game execution unit 300a displays the lottery result on the touch panel 26. In addition, the lottery game execution unit 300a stores information relating to the obtained nurture game content in the storage unit 18. Here, the lottery game execution unit 300a updates the possession information of the newly obtained nurture game content in the possession information storage unit 330.

When a strengthening operation for strengthening the nurture game content is input on the strengthening screen, the strengthening execution unit 302a executes strengthen request processing. In the strengthening request processing, strengthening request information is transmitted to the server 1000. When the strengthening request information is received, the server 1000 executes strengthening processing to increase the level of the nurture game content selected by the player by consuming an item or in-game currency. Here, in the server 1000, the possession information of a nurture game content having the same type as the nurture game content selected by the player and having a higher level than the nurture game content currently possessed is updated to “possession”. Further, the server 1000 causes the player terminal 1 to receive strengthen information indicating a result of the strengthen processing.

Upon receiving the strengthen information, the strengthening execution unit 302a displays a result of the strengthening on the touch panel 26. Further, the strengthening execution unit 302a updates the possession information in the possession information storage unit 330 as in the server 1000. In this manner, the level of the nurture game content selected by the player is updated.

When a race start operation for starting a racing game is input on the racing game selection screen, the game execution unit 304a executes selected information transmission processing. In the selected information transmission processing, selected information necessary for execution of the racing game, such as the type of the selected race, is transmitted. Upon receiving the selection information, the server 1000 executes racing game processing such as deriving a race result by computational processing.

The nurtured character selected by the player participates in the racing game. When the racing game is executed, the affinity level of the character associated with the nurtured character participating in the racing game increases. Here, the affinity level associated with the game content ID associated with the nurtured character is updated. In addition, the server 1000 causes the player terminal 1 to receive race result information indicating the race result and information related to the affinity level of the character.

Upon receiving the race result information and the like, the game execution unit 304a executes race display processing on the basis of the received race result information. Here, the game execution unit 304a generates and displays a race commentary images on the basis of the race result information. In addition, when the affinity level associated with the game content ID is updated in the server 1000, the affinity level associated with the game content ID is similarly updated also in the possession information storage unit 330 of the player terminal 1.

When the live show select button 106 is operated on the home screen 100, the live show performance preparation processing unit 306a executes live show performance preparation processing. An example of the processing executed by the live show performance preparation processing unit 306a will be described in detail below.

FIG. 18 is a flowchart for describing an example of the live show performance preparation processing in the player terminal 1. The live show performance preparation processing unit 306a executes live show music selection processing (P10). In the live show music selection processing, the live show performance preparation processing unit 306a displays the live show music piece selection screen 110. When a music switching operation (for example, a swipe/flick operation in the left-and-right direction on the live show music piece selection screen 110) is input while the live show music piece selection screen 110 is displayed, the live show performance preparation processing unit 306a switches the jacket image 112 displayed on the live show music piece selection screen 110. Further, the live show performance preparation processing unit 306a stores the music piece corresponding to the jacket image 112a as the selected music piece.

When the live show preparation button 116 is operated while the live show music piece selection screen 110 is displayed, the live show performance preparation processing unit 306a reads out music piece information of the music piece stored as the selected music piece. Although detailed description is omitted, music piece information is stored in the data storage area 12b for each music piece. The music piece information includes position numbers, a position classification (whether it is a main position or a back position) set to each number, initial settings information of game contents ID and outfit IDs initially set to each number, image data of the live show preparation screen 120, and the like.

The live show performance preparation processing unit 306a sets initial settings information as character settings information in the settings information storage unit 332 on the basis of the read music piece information. The character settings information stored in the settings information storage unit 332 is information in which game content IDs, outfit IDs, head IDs, tail IDs, and the like are associated with each position number. Then, the live show performance preparation processing unit 306a displays the live show preparation screen 120 on the basis of the character settings information set in the settings information storage unit 332, that is, the initial settings information.

When the live show preparation screen 120 is displayed as described above, the live show performance preparation processing unit 306a executes in-live-show-preparation-screen-display processing.

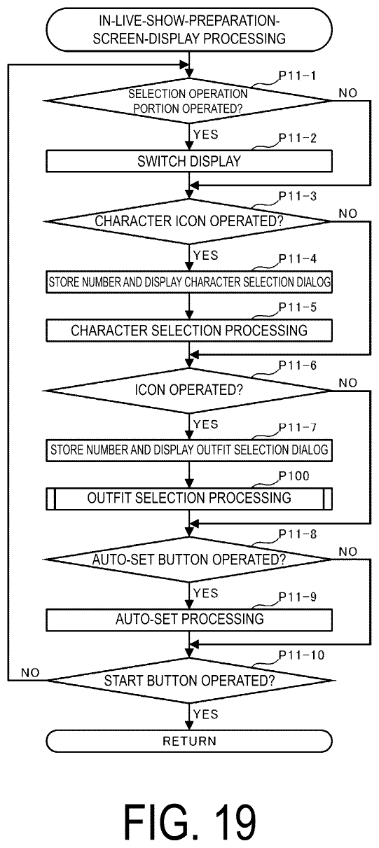

FIG. 19 is a flowchart for describing an example of the in-live-show-preparation-screen-display processing in the player terminal 1. When the selection operation portion (the main position selection operation portion 122a or the back position selection operation portion 122b) is operated on the live show preparation screen 120 (YES in P11-1), the live show performance preparation processing unit 306a displays the main setting screen 120a or the back setting screen 120b on the basis of the operated selection operation portion (P11-2).

When the character icon 128 is operated on the live show preparation screen 120 (YES in P11-3), the live show performance preparation processing unit 306a stores the position number associated with the operated character icon 128 and displays the character selection dialog 150 (P11-4). Here, the live show performance preparation processing unit 306a obtains the game content ID of the possessed character. Then, the live show performance preparation processing unit 306a displays the character icon 128 corresponding to the obtained game content ID on the character selection dialog 150.

When the character selection dialog 150 is displayed, the live show performance preparation processing unit 306a executes character selection processing (P11-5). The character selection processing is executed while the character selection dialog 150 is displayed. Here, when the character icon 128 of the character selection dialog 150 is operated, the live show performance preparation processing unit 306a stores the game content ID corresponding to the operated character icon 128 as the game content ID in the provisionally selected state.

In addition, when the not-designated button 128a of the character selection dialog 150 is operated, the live show performance preparation processing unit 306a determines a mob character and stores a game content ID dedicated to the determined mob character as the game content ID in the provisionally selected state. In this case, the mob character is randomly determined, but any character may be determined from among possessed characters possessed by the player. The not-designated button 128a is not essential.

When the cancel button 150a of the character selection dialog 150 is operated, the live show performance preparation processing unit 306a hides the character selection dialog 150. As a result, the live show preparation screen 120 is displayed.

When the select button 150b of the character selection dialog 150 is operated, the live show performance preparation processing unit 306a stores the game content ID in the provisionally selected state in association with the position number stored in P11-4 in the character settings information of the settings information storage unit 332. In this case, the live show performance preparation processing unit 306a hides the character selection dialog 150 and displays the live show preparation screen 120. At this time, the live show performance preparation processing unit 306a displays the character icon 128 and the image images 126 and 130 corresponding to the changed game content ID on the live show preparation screen 120.

When the outfit icon 132 on the live show preparation screen 120 is operated (YES in P11-6), the live show performance preparation processing unit 306a stores the position number associated with the operated outfit icon 132 and displays the outfit selection dialog 160 (P11-7). Here, the live show performance preparation processing unit 306a obtains the game content ID set to the position number associated with the operated outfit icon 132 on the basis of the character settings information stored in the settings information storage unit 332. Then, the live show performance preparation processing unit 306a extracts an outfit ID that can be set to the obtained game content ID, in other words, an outfit ID that satisfies the wearing condition. In addition, the live show performance preparation processing unit 306a displays a list of outfit icons 132 corresponding to the extracted outfit IDs in the outfit selection dialog 160.

When the outfit selection dialog 160 is displayed, the live show performance preparation processing unit 306a executes outfit selection processing (P100). The outfit selection processing is processing during display of the outfit selection dialog 160 and is processing of enabling the player to select an outfit.

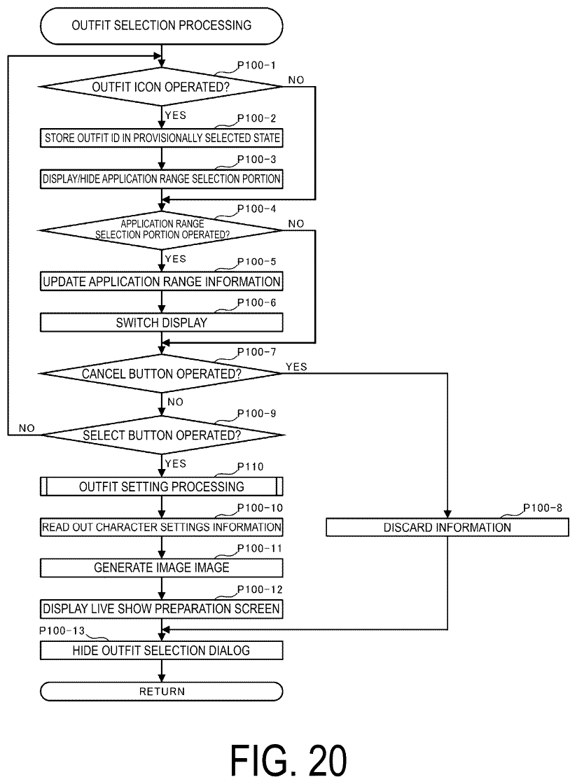

FIG. 20 is a flowchart for describing an example of the outfit selection processing (P100) in the player terminal 1. When the outfit icon 132 of the outfit selection dialog 160 is operated (YES in P100-1), the live show performance preparation processing unit 306a stores the outfit ID corresponding to the operated outfit icon 132 as the outfit ID in the provisionally selected state (P100-2).

Further, the live show performance preparation processing unit 306a displays the second display area 162 in the outfit selection dialog 160 when the outfit ID in the provisionally selected state is a target of the collective setting function and hides the second display area 162 when the outfit ID is not a target of the collective setting function (P100-3). When the outfit ID in the provisionally selected state is a target of the collective setting function, the live show performance preparation processing unit 306a displays a message for each outfit type in the vicinity of the check box 162a in the second display area 162. That is, here, the live show performance preparation processing unit 306a changes the display of the second display area 162 by the selected outfit icon 132 in the outfit selection dialog 160.

When the second display area 162 of the outfit selection dialog 160, that is, the check box 162a, the partial character selection toggle 164a, or the all character selection toggle 164b is operated (YES in P100-4), the live show performance preparation processing unit 306a updates the application range information indicating the application range of the collective setting function (P100-5). Further, the live show performance preparation processing unit 306a switches the display of the second display area 162 on the basis of the operated second display area 162 (P100-6). Here, for example, the display modes of the check box 162a, the partial character selection toggle 164a, and the all character selection toggle 164b are updated.

When the cancel button 160b of the outfit selection dialog 160 is operated (YES in P100-7), the live show performance preparation processing unit 306a discards the outfit ID and the application range information in the provisionally selected state (P100-8). Then, the live show performance preparation processing unit 306a hides the outfit selection dialog 160 (P100-3). When the outfit selection dialog 160 is hidden, the live show preparation screen 120 is displayed.

When the select button 160a of the outfit selection dialog 160 is operated (YES in P100-9), the live show performance preparation processing unit 306a executes outfit setting processing (P110).

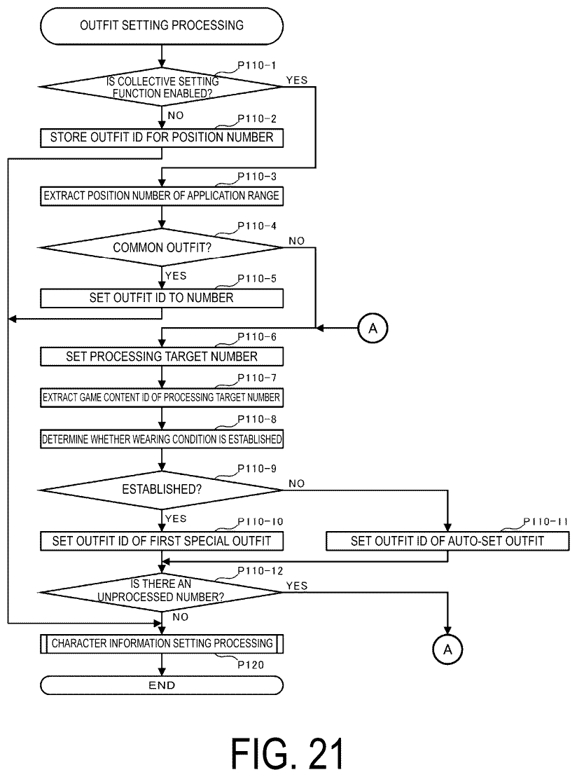

FIG. 21 is a flowchart for describing an example of the outfit setting processing (P110) in the player terminal 1. The live show performance preparation processing unit 306a determines whether the collective setting function is enabled on the basis of the application range information set in P100-5 (P110-1). In a case where the collective setting function is not enabled (NO in P110-1), the live show performance preparation processing unit 306a stores the outfit ID in the provisionally selected state in association with the position number stored in P11-7 in the character settings information of the settings information storage unit 332 (P110-2).

When the collective setting function is enabled (YES in P110-1), the live show performance preparation processing unit 306a extracts all of the position numbers in the application range of the collective setting function on the basis of the application range information (P110-3). When the outfit ID in the provisionally selected state is the outfit ID of a common outfit (YES in P110-4), the live show performance preparation processing unit 306a stores the outfit ID in the provisionally selected state in association with all of the numbers extracted in P110-3 in the character settings information of the settings information storage unit 332 (P110-5).

When the collective setting function is enabled (YES in P110-1) and the outfit ID in the provisionally selected state is not the outfit ID of a common outfit (NO in P110-4), the live show performance preparation processing unit 306a sets one of the numbers extracted in P110-3 as the processing target number (P110-6). In this flowchart, the case where NO is determined in P110-4 is limited to the case where the outfit ID in the provisionally selected state is the outfit ID for the first special outfit, but another special outfit may be determined or a plurality of special outfits may be determined.

Then, the live show performance preparation processing unit 306a extracts the game content ID associated with the processing target number from the character settings information in the settings information storage unit 332 (P110-7). In addition, the live show performance preparation processing unit 306a determines whether the wearing condition of the first special outfit associated with the game content ID extracted in P110-7 is satisfied (P110-8).

When the wearing condition is satisfied (YES in P110-9), the live show performance preparation processing unit 306a stores the outfit ID having the first special outfit identification information of “1”, from among the outfit IDs associated with the game content ID extracted in P110-7, in association with the processing target number in the character settings information in the settings information storage unit 332 (P110-10). On the other hand, when the wearing condition is not satisfied (NO in P110-9), the live show performance preparation processing unit 306a stores the outfit ID of the auto-set outfit in association with the processing target number in the character settings information of the settings information storage unit 332 (P110-11).

Then, when there is a number that has not been processed after P110-6 from among the numbers extracted in P110-3 (YES in P110-12), the live show performance preparation processing unit 306a repeats the processing from P110-6. In P110-6, unprocessed numbers are sequentially set, and outfit IDs are set for all the extracted numbers. When the outfit IDs are set for all the numbers extracted in P110-3 (NO in P110-12), the live show performance preparation processing unit 306a executes character information setting processing (P120).

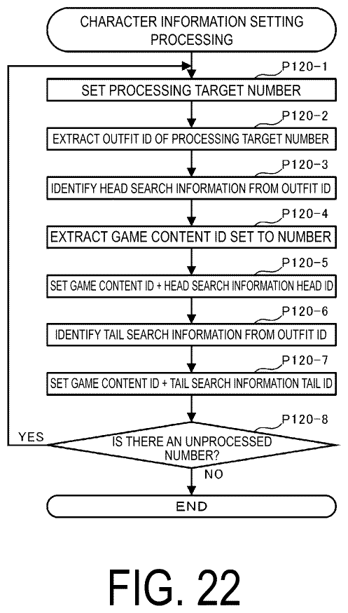

FIG. 22 is a flowchart for describing an example of the character information setting processing (P120) in the player terminal 1. The live show performance preparation processing unit 306a sets either the number stored in P11-7 or the number extracted in P110-3 as the processing target number (P120-1). Then, the live show performance preparation processing unit 306a extracts the outfit ID associated with the processing target number from the character settings information in the settings information storage unit 332 (P120-2). Further, the live show performance preparation processing unit 306a identifies the head search information associated with the outfit ID extracted in P120-2 (P120-3).

Further, the live show performance preparation processing unit 306a extracts the game content ID associated with the processing target number from the character settings information in the settings information storage unit 332 (P120-4). In addition, the live show performance preparation processing unit 306a sets the head ID obtained by adding the value of the head search information identified in P120-3 to the end of the game content ID extracted in P120-4 (P120-5). Here, in the character settings information of the settings information storage unit 332, the head ID is associated with the processing target number.

Further, the live show performance preparation processing unit 306a identifies the tail search information associated with the outfit ID extracted in P120-2 (P120-6). In addition, the live show performance preparation processing unit 306a sets the tail ID obtained by adding the value of the tail search information identified in P120-6 to the end of the game content ID extracted in P120-4 (P120-7). Here, in the character settings information of the settings information storage unit 332, the tail ID is associated with the processing target number.

Then, when there is a number that has not been processed after P120-1 from among the numbers stored in P11-7 or extracted in P110-3 (YES in P120-8), the live show performance preparation processing unit 306a repeats the processing from P120-1. In P120-1, unprocessed numbers are sequentially set, and the head IDs and the tail IDs are set for all the extracted numbers. When the head IDs and the tail IDs are set for all of the numbers stored in P11-7 or extracted in P110-3 (NO in P120-8), the character information setting processing (P120) and the outfit setting processing (P110) end.

Returning to FIG. 20, the live show performance preparation processing unit 306a reads out the character settings information of the settings information storage unit 332 (P100-10), and generates the image images 126 and 130 (P100-11). Then, the live show performance preparation processing unit 306a displays the live show preparation screen 120 (P100-12). At this time, the image images 126 and 130 generated in P100-11 are displayed on the live show preparation screen 120, and the character icon 128 and the outfit icon 132 are displayed on the basis of the character settings information. Then, the live show performance preparation processing unit 306a hides the outfit selection dialog 160 (P100-13).

Returning to FIG. 19, when the auto-set button 134 on the live show preparation screen 120 is operated (YES in P11-8), the live show performance preparation processing unit 306a executes auto-set processing (P11-9). Here, an auto-set screen is displayed, and the characters and outfits are automatically set on the basis of player operation.

When the start button 136 of the live show preparation screen 120 is operated (YES in P11-10), the live show performance preparation processing unit 306a hides the live show preparation screen 120 and ends the in-live-show-preparation-screen-display processing.

When the in-live-show-preparation-screen-display processing is finished, as illustrated in FIG. 18, the live show performance execution unit 308a reads out the character settings information stored in the settings information storage unit 332 (P12). Then, the live show performance execution unit 308a generates a live show video including a character image on the basis of the character settings information read out in P12 and executes a live show performance (P13). Thus, the live show video including the character wearing the outfit set by the player is played.

The above-described collective setting function is executed in the above-described processing. According to the collective setting function of the present embodiment, a common outfit and an individual outfit can be collectively set for a plurality of characters. When the common outfit is collectively set, the same outfit is worn by a plurality of characters, and when the individual outfit is collectively set, different outfits are worn by a plurality of characters.

When the collective setting function for the individual outfit is used, it is determined whether the individual outfit is wearable for each game content ID, and different outfit IDs are stored in association with the game content ID determined to be wearable. Since images having different designs are associated with respective outfit IDs, characters included in the application range of the collective setting put on individual outfits having different appearances. In this manner, since different outfits can be collectively set for a plurality of characters, it is possible to achieve both enhancing the operability and diversifying the performance.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present invention.

In the above-described embodiment, a live show performance in which a character performs singing and/or dancing has been described as an example of a performance. However, the technical matters described above are applicable not only to a live show performance but also to any scene displayed on a game screen. In the above-described embodiment, the object displayed on the game screen is a character, and the player can set an outfit of the character. However, the object displayed on the game screen is not limited to a character. For example, the object displayed on the game screen may be a card in a digital card game or a design displayed on the card. The object displayed on the game screen may be a card or an item displayed on a game screen in various games. The object displayed on the game screen may be a flying object in a shooting game. Furthermore, the object displayed on the game screen may be a character or an item displayed in a square in a simulation game.

The appearance of the object that can be set by the player is not limited to an outfit of a character. The appearance of the object that can be set by the player may be, for example, a uniform, a weapon, or armor possessed by a character in a sports game, an RPG, or an action game. In addition, for example, the player may be able to set the design and equipment of a flying object in a shooting game.

In addition, the game screen described above is merely an example, and the game screen described using the drawings can be appropriately changed in design.

Further, in the above-described embodiment, processing related to the live show performance is executed in the player terminal 1. However, the processing related to the live show performance may be executed in the server 1000 or may be executed by cooperation between the player terminal 1 and the server 1000.

In any case, an information processing program causes one or more computers to execute the following processing.

### Processing Executed by Computer

Processing (in the embodiment, for example, P11-7) of displaying a selection screen (in the embodiment, for example, the outfit selection dialog 160) including a first display area (in the embodiment, for example, the first display area 161) where a display type of an appearance of an object (in the embodiment, for example, a character) displayed on a game screen is selectable, and where a common display type with a common appearance (in the embodiment, for example, an outfit) for a plurality of objects or a special display type (in the embodiment, for example, the first special outfit group) with different appearances for a plurality of objects is selectable, and a second display area (in the embodiment, for example, the second display area 162) where an application range of the display type selected by a player is selectable, and where a predetermined object or a plurality of objects are selectable as the application range.

Processing (in the embodiment, for example, P100-3) of changing a display of the second display area depending on the display type selected on the selection screen.

Processing (in the embodiment, for example, P110-5, P100-11, and P100-12), in a case where the common display type is selected, of displaying at least the predetermined object with an appearance corresponding to the common display type.

Processing (in the embodiment, for example, P110-8), in a case where the special display type is selected and the plurality of objects are selected as the application range, of determining whether a display condition is satisfied for each of the plurality of objects.

Processing (in the embodiment, for example, P110-10, P100-11, and P100-12) of displaying, from among the plurality of objects, an object determined to satisfy the display condition with an appearance corresponding to the special display type.

In the above-described embodiment, the outfit icon 132 is displayed in the first display area 161 in a selectable manner. Since one outfit is associated with the outfit icon 132, the player can select the type of outfit, that is, the display type of outfit by selecting the outfit icon 132. In the above-described embodiment, a list of the selectable outfit icons 132 is displayed in the first display area 161 of the outfit selection dialog 160. Since the outfit icons 132 are displayed in a list, visibility and operability are enhanced, and even when there are many selectable outfits, the player can easily select their favorite outfits.

In the above-described embodiment, only the outfit icon 132 corresponding to the outfit wearable by the selected character is displayed in the first display area 161. However, the outfit icons 132 corresponding to all outfits may be displayed in the first display area 161 regardless of whether the outfits can be worn. In this case, for example, an outfit that can be worn by the selected character and an outfit that cannot be worn by the selected character may be displayed in a distinguishable manner. Further, in this case, even when an outfit that cannot be worn by the selected character is selected, the selected outfit may be set to another character by using the collective setting function.

The display type of each outfit is roughly classified into the common display type and the individual display type. Thus, the player can be considered to select the common display type or the individual display type as the display type of the outfit of the character by selecting the outfit icon 132. For example, in the first display area 161, the player may be allowed to select one of the common display type and the individual display type (special display type). In this case, outfits (appearance) corresponding to the selected display type can be selected in another display area of the outfit selection dialog 160 or in a dialog different from the outfit selection dialog 160.

In addition, as an example of a case where the display of the second display area is changed depending on the display type selected on the selection screen, the case where the presence/absence and content of a message displayed in the second display area 162 are changed has been described in the above-described embodiment. However, as the mode of changing the display of the second display area, for example, the display color may be changed, or the mode may change to make it distinguishable whether operation input is enabled or disabled.

Further, in the above-described embodiment, when the common outfit is selected and a plurality of characters are not selected as the application range, the common outfit is set only to the character selected in advance by the player. On the other hand, when the common outfit is selected and a plurality of characters are selected as the application range, the common outfit is set to the plurality of characters. In this manner, when the common outfit is selected, the common outfit is set to at least one or a plurality of predetermined characters.

In the above-described embodiment, when the player changes the settings of the outfit, the character wearing the outfit after the setting change is displayed on the live show preparation screen 120. Thus, the player can confirm the outfit of each character before the live show performance and can execute the live show performance as intended.

The object may include an object displayable with an appearance corresponding to the special display type (in the embodiment, for example, a character that satisfies the wearing condition) and an object non-displayable with an appearance corresponding to the special display type (in the embodiment, for example, a character that does not satisfy the wearing condition).

Further, identification information (in the embodiment, for example, a level associated with a nurture game content, possession information, an affinity level associated with game content ID) for identifying an object displayable with an appearance corresponding to the special display type and an object non-displayable with an appearance corresponding to the special display type may be provided.

In a case where an object non-displayable with an appearance corresponding to the special display type has satisfied a predetermined condition, processing (in the embodiment, for example, the processing of updating the information of the possession information storage unit 330 via the lottery game execution unit 300a, the strengthening execution unit 302a, the game execution unit 304a) of enabling the object to be displayed with an appearance corresponding to the special display type may be executed. The game screen may include a game screen displaying the object arranged in each of position 1 (in the embodiment, for example, a main position) and position 2 (in the embodiment, for example, a back position).

Processing (in the embodiment, for example, P10) of enabling the player to select the object arranged in position 1 or position 2 may be executed.

In a case where an object arranged in position 1 is selected, selection of whether to include all objects arranged in position 1 as the application range in the second display area or whether to include all objects displayed on the game screen as the application range in the second display area may be enabled.

Further, in a case where an object arranged in position 2 is selected, selection of whether to include all objects arranged in position 2 as the application range in the second display area or whether to include all objects displayed on the game screen as the application range in the second display area may be enabled.

That is, in the above-described embodiment, the positions where characters are arranged are roughly classified into two types of positions. Thus, even when the same character appears in live show performances, the performances can be diversified by making the arrangement of each character different. Further, the arrangement and outfit setting of each character can be realized with a simple operation. However, only one type of position may be provided. In addition, for example, the range of characters for which the common outfit or the individual outfit is collectively set may be only all characters. Alternatively, only either of the characters in the main position or the characters in the back position may be a target of the collective setting.

In the above-described embodiment, the information processing program for realizing the game may be stored in a non-transitory computer-readable storage medium. In addition, the above-described embodiment may correspond to an information processing method for implementing each function and the steps illustrated in the flowcharts.

What is claimed is:

1. A non-transitory computer readable medium storing a program causing a computer to execute:
processing of displaying a selection screen including
a first display area where a display type of an appearance of an object displayed on a game screen is selectable, and where a common display type with a common appearance for a plurality of objects or a special display type with different appearances for the plurality of objects is selectable, and
a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.

2. The non-transitory computer readable medium according to claim 1, wherein
the object includes an object displayable with an appearance corresponding to the special display type and an object non-displayable with an appearance corresponding to the special display type,
identification information for identifying an object displayable with an appearance corresponding to the special display type and an object non-displayable with an appearance corresponding to the special display type is provided, and
the program further causes the computer to execute:
processing, in a case where an object non-displayable with an appearance corresponding to the special display type has satisfied a predetermined condition, of enabling the object to be displayed with an appearance corresponding to the special display type.

3. The non-transitory computer readable medium according to claim 1, wherein
the game screen includes a game screen displaying the object arranged in each of a position 1 and a position 2,
the program further causes the computer to execute:
processing of enabling a player to select the object arranged in the position 1 or the position 2,
the predetermined object is an object selected by a player, and
the processing of displaying the selection screen
enables, in a case where an object arranged in the position 1 is selected, selection of whether to include all objects arranged in the position 1 as the application range in the second display area or whether to include all objects displayed on the game screen as the application range in the second display area, and
enables, in a case where an object arranged in the position 2 is selected, selection of whether to include all objects arranged in the position 2 as the application range in the second display area or whether to include all objects displayed on the game screen as the application range in the second display area.

4. An information processing method executed by one or more computers, the information processing method comprising:
processing of displaying a selection screen including
a first display area where a display type of an appearance of an object displayed on a game screen is selectable, and where a common display type with a common appearance for a plurality of objects or a special display type with different appearances for the plurality of objects is selectable, and
a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.

5. An information processing system comprising one or more computers, the information processing system executing:
by the one or more computers,
processing of displaying a selection screen including
a first display area where a display type of an appearance of an object displayed on a game screen is selectable, and where a common display type with a common appearance for a plurality of objects or a special display type with different appearances for the plurality of objects is selectable, and
a second display area where an application range of the display type selected by a player is selectable, and where a predetermined object or a plurality of objects are selectable as the application range;
processing of changing a display of the second display area depending on the display type selected, on the selection screen;
processing, in a case where the common display type is selected, of displaying at least the predetermined object with an appearance corresponding to the common display type;
processing, in a case where the special display type is selected and the plurality of objects are selected as the application range, of determining whether a display condition is satisfied for each of the plurality of objects; and
processing of displaying, from among the plurality of objects, an object determined to satisfy the display condition with an appearance corresponding to the special display type.
